(19) United States
(12) Patent Application Publication
(10) Pub. No.: US 2024/0004116 A1
(43) Pub. Date: Jan. 4, 2024

(54) LIQUID CRYSTAL COMPOSITION, OPTICAL ELEMENT, AND LIGHT GUIDE ELEMENT

(71) Applicant: FUJIFILM Corporation, Tokyo (JP)

(72) Inventors: Megumi OKUBO, Kanagawa (JP); Mitsuyoshi ICHIHASHI, Kanagawa (JP); Yuki FUKUSHIMA, Kanagawa (JP); Keisuke KODAMA, Kanagawa (JP); Shunya KATOH, Kanagawa (JP)

(73) Assignee: FUJIFILM Corporation, Tokyo (JP)

(21) Appl. No.: 18/467,447

(22) Filed: Sep. 14, 2023

Related U.S. Application Data
(63) Continuation of application No. PCT/JP2022/013045, filed on Mar. 22, 2022.

(30) Foreign Application Priority Data
Mar. 22, 2021 (JP) 2021-047453

(51) Int. Cl. G02B 5/30; C09K 19/38

(52) U.S. Cl. CPC G02B 5/3016; C09K 19/3861; C09K 2019/0448

(57) ABSTRACT

Regarding an optical element that includes an optically-anisotropic layer having a liquid crystal alignment pattern where a direction of an optical axis derived from a liquid crystal compound changes while continuously rotating in at least one in-plane direction, an object of the present invention is to provide a liquid crystal composition with which an optical element having an excellent diffraction efficiency can be prepared, and an optical element and a light guide element. The liquid crystal composition according to the present invention includes a rod-like liquid crystal compound and a disk-like liquid crystal compound, and a ratio between a twist elastic constant K22 and a splay elastic constant K11 of the liquid crystal composition satisfies 0.7≤K22/K11.

### CROSS-REFERENCE TO RELATED APPLICATIONS

This application is a Continuation of PCT International Application No. PCT/JP2022/013045 filed on Mar. 22, 2022, which claims priority under 35 U.S.C. § 119(a) to Japanese Patent Application No. 2021-047453 filed on Mar. 22, 2021. The above applications are hereby expressly incorporated by reference, in their entirety, into the present application.

### BACKGROUND OF THE INVENTION

### 1. Field of the Invention

The present invention relates to a liquid crystal composition, an optical element, and a light guide element.

### 2. Description of the Related Art

In many optical devices, optical systems, and the like, polarized light is used. Accordingly, the development of an optical element that controls reflection, focusing, divergence, or the like of polarized light has progressed.

For example, JP2017-522601A describes an optical element comprising a plurality of stacked birefringent sublayers configured to alter a direction of propagation of light passing therethrough according to a Bragg condition, in which the stacked birefringent sublayers respectively comprise local optical axes that vary along respective interfaces between adjacent ones of the stacked birefringent sublayers to define respective grating periods.

The optical element described in JP2017-522601A includes an optically anisotropic thin film (that is, a liquid crystal layer of the thin film) including a liquid crystal compound. Specifically, the optical element described in JP2017-522601A is a diffraction element including a liquid crystal layer that diffracts light by changing an alignment pattern of a rod-like liquid crystal compound in one in-plane direction.

The diffraction element formed of the liquid crystal compound is expected to be used as an optical member, for example, an image projection device such as augmented reality (AR) glasses.

In AR glasses, for example, an image displayed by a display is incident into one end of a light guide plate, propagates in the light guide plate, and is emitted from another end of the light guide plate such that the virtual image is displayed to be superimposed on a scene that a user is actually seeing.

In AR glasses, light (projection light) projected from a display is diffracted (refracted) using a diffraction element to be incident into one end part of a light guide plate. As a result, the light is introduced into the light guide plate at an angle such that the light is totally reflected and propagates in the light guide plate. The light propagated in the light guide plate is also diffracted by the diffraction element in the other end part of the light guide plate and is emitted from the light guide plate to an observation position by the user.

### SUMMARY OF THE INVENTION

The present inventors conducted an investigation on the optical element described in JP2017-522601A and clarified that, in a case where an optical element is prepared using a generic liquid crystal composition, the diffraction efficiency may deteriorate.

Accordingly, regarding an optical element that includes an optically-anisotropic layer having a liquid crystal alignment pattern where a direction of an optical axis derived from a liquid crystal compound changes while continuously rotating in at least one in-plane direction, an object of the present invention is to provide a liquid crystal composition with which an optical element having an excellent diffraction efficiency can be prepared, and an optical element and a light guide element.

As a result of conducting a thorough investigation to achieve the above-described object, the present inventors found that, in a case where a liquid crystal composition including a rod-like liquid crystal compound and a disk-like liquid crystal compound is used, an optical element having an excellent diffraction efficiency can be prepared, thereby completing the present invention.

That is, the present inventors found that the object can be achieved with the following configurations.
[1] A liquid crystal composition comprising:
a liquid crystal compound,
in which the liquid crystal composition includes a rod-like liquid crystal compound and a disk-like liquid crystal compound, and
a ratio between a twist elastic constant K22 and a splay elastic constant K11 of the liquid crystal composition satisfies 0.7≤K22/K11.
[2] The liquid crystal composition according to [1],
in which a difference Δn₅₅₀ in refractive index generated by refractive index anisotropy of the liquid crystal composition is 0.2 or more.
[3] The liquid crystal composition according to [1] or [2],
in which a content of the disk-like liquid crystal compound in the liquid crystal composition with respect to a total mass of the rod-like liquid crystal compound and the disk-like liquid crystal compound in the liquid crystal composition is 5 to 25 mass %.
[4] The liquid crystal composition according to any one of [1] to [3],
in which the rod-like liquid crystal compound is a compound represented by Formula (I) described below.
[5] The liquid crystal composition according to any one of [1] to [4],
in which the disk-like liquid crystal compound is a compound represented by Formula (II) described below.
[6] The liquid crystal composition according to claim 4,
wherein at least one Y¹ in Formula (I) represents —C≡C—.
[7] An optical element comprising:
an optically-anisotropic layer that is formed of a liquid crystal composition including a liquid crystal compound,
in which the liquid crystal composition includes a rod-like liquid crystal compound and a disk-like liquid crystal compound, and
the optically-anisotropic layer has a liquid crystal alignment pattern in which a direction of an optical axis derived from the liquid crystal compound changes while continuously rotating in at least one in-plane direction.
[8] The optical element according to [7],
in which the liquid crystal composition is the liquid crystal composition according to any one of [1] to [6].
[9] The optical element according to [7] or [8],
in which the directions of the optical axes in the optically-anisotropic layer match each other in a thickness direction.
[10] The optical element according to [7] or [8],
in which the optically-anisotropic layer has a region where the direction of the optical axis is twisted in a thickness direction and rotates.
[11] The optical element according to any one of [7] to [10],
in which in a case where a length over which the direction of the optical axis rotates by 180° in a plane is set as a single period, the optically-anisotropic layer has regions having different lengths of the single periods in the liquid crystal alignment pattern.
[12] The optical element according to any one of [7] to [11],
in which the single period in the liquid crystal alignment pattern gradually decreases in the one in-plane direction in which the direction of the optical axis changes while continuously rotating in the liquid crystal alignment pattern.
[13] The optical element according to any one of [7] to [12],
in which the liquid crystal alignment pattern of the optically-anisotropic layer is a concentric circular pattern having a concentric circular shape where the one in-plane direction in which the direction of the optical axis changes while continuously rotating moves from an inner side toward an outer side.
[14] Alight guide element comprising:
the optical element according to any one of [7] to [13]; and
a light guide plate.

According to the present invention, regarding an optical element that includes an optically-anisotropic layer having a liquid crystal alignment pattern where a direction of an optical axis derived from a liquid crystal compound changes while continuously rotating in at least one in-plane direction, it is possible to provide a liquid crystal composition with which an optical element having an excellent diffraction efficiency can be prepared, and an optical element and a light guide element.

### BRIEF DESCRIPTION OF THE DRAWINGS

FIG. 1 is a diagram conceptually showing an example of an optical element according to the present invention.

FIG. 2 is a conceptual diagram showing the optical element shown in FIG. 1.

FIG. 3 is a plan view showing the optical element shown in FIG. 1.

FIG. 4 is a conceptual diagram showing an action of the optical element shown in FIG. 1.

FIG. 5 is a diagram conceptually showing another example of the optical element according to the present invention.

FIG. 6 is a diagram conceptually showing another example of the optical element according to the present invention.

FIG. 7 is a plan view showing the optical element shown in FIG. 6.

FIG. 8 is a conceptual diagram showing an action of the optical element shown in FIG. 6.

FIG. 9 is a conceptual diagram showing the action of the optical element shown in FIG. 6.

FIG. 10 is a diagram conceptually showing an example of an exposure device that exposes an alignment film of the diffraction element shown in FIGS. 2 and 6.

FIG. 11 is a diagram conceptually showing another example of an optically-anisotropic layer of the optical element according to the present invention.

FIG. 12 is a diagram conceptually showing one example of an exposure device that exposes an alignment film forming the optically-anisotropic layer shown in FIG. 11.

FIG. 13 is a conceptual diagram showing AR glasses including a light guide element according to the present invention including the optical element shown in FIG. 1.

### DESCRIPTION OF THE PREFERRED EMBODIMENTS

Hereinafter, the details of the present invention will be described.

The following description regarding components has been made based on a representative embodiment of the present invention. However, the present invention is not limited to the embodiment.

In the present specification, numerical ranges represented by “to” include numerical values before and after “to” as lower limit values and upper limit values.

In the present specification, materials that correspond to each of components may be used alone or in combination of two or more kinds. Here, in a case where two or more kinds of materials are used in combination for each of components, the content of the component refers to the total content of the materials to be combined unless specified otherwise.

In the present specification, “(meth)acrylate” represents “either or both of acrylate and methacrylate”.

[Liquid Crystal Composition]

A liquid crystal composition according to the embodiment of the present invention is a liquid crystal composition including a liquid crystal compound, in which the liquid crystal compound includes a rod-like liquid crystal compound and a disk-like liquid crystal compound, and
a ratio between a twist elastic constant (K22) and a splay elastic constant (K11) satisfies 0.7≤K22/K11.

In the present invention, the ratio (K22/K11) between the twist elastic constant (K22) and the splay elastic constant (K11) is preferably 0.7 to 2.0 and more preferably 0.75 to 1.5.

Here, the elastic constant of the liquid crystal composition is an elastic constant of the liquid crystal composition other than a solvent.

In addition, the ratio (K22/K11) between the twist elastic constant (K22) and the splay elastic constant (K11) refers to a value measured using the following method.

First, a cell thickness, incident polarization of light scattering measurement, an alignment direction of liquid crystal, and light receiving and polarization conditions are selected according to the document “G. Chen et al., Jpn. J. Appl. Phys. 28, 56 (1989).

Next, using a principle formula described in the document “R. Akiyama et al., Jpn. J. Appl. Phys. 19, 1937 (1980)” and an experimental correction formula described in the document “G. Chen et al., Jpn. J. Appl. Phys. 28, 56 (1989)”, angle dependence of light scattering is analyzed and measured.

In the present invention, as described above, in a case where a liquid crystal composition including a rod-like liquid crystal compound and a disk-like liquid crystal compound is used, an optical element having an excellent diffraction efficiency can be prepared.

The details of the reason for this are not clear, but the present inventors presumed the reason to be as follows.

That is, in the present invention, by forming the optically-anisotropic layer using the liquid crystal composition including the rod-like liquid crystal compound and the disk-like liquid crystal compound, twist deformation of the rod-like liquid crystal compound can be suppressed as compared to a case where only the rod-like liquid crystal compound is mixed. Therefore, in a case where a liquid crystal alignment pattern in which a direction of an optical axis derived from a liquid crystal compound changes while continuously rotating in at least one in-plane direction is formed, pattern aligning properties are improved, and thus it is presumed that an optical element having an excellent diffraction efficiency can be prepared.

Hereinafter, each of the components of the liquid crystal composition according to the embodiment of the present invention will be described in detail.

[Liquid Crystal Compound]

The liquid crystal compounds in the liquid crystal composition according to the embodiment of the present invention are a rod-like liquid crystal compound and a disk-like liquid crystal compound.

In addition, as the liquid crystal compound, any one of a low-molecular-weight liquid crystal compound or a polymer liquid crystal compound can be used.

Here, “low-molecular-weight liquid crystal compound” refers to a liquid crystal compound not including a repeating unit in a chemical structure.

In addition, “polymer liquid crystal compound” refers to a liquid crystal compound including a repeating unit in a chemical structure.

<Rod-Like Liquid Crystal Compound>

Examples of the rod-like liquid crystal compound include an azomethine compound, an azoxy compound, a cyanobiphenyl compound, a cyanophenyl ester compound, a benzoate compound, a phenyl cyclohexanecarboxylate compound, a cyanophenylcyclohexane compound, a cyano-substituted phenylpyrimidine compound, an alkoxy-substituted phenylpyrimidine compound, a phenyldioxane compound, a tolan compound, and an alkenylcyclohexylbenzonitrile compound.

Specific examples of the rod-like liquid crystal compound include compounds described in Makromol. Chem. (1989), Vol. 190, p. 2255, Advanced Materials (1993), Vol. 5, p. 107, U.S. Pat. Nos. 4,683,327A, 5,622,648A, 5,770,107A, WO95/22586, WO95/24455, WO97/00600, WO98/23580, WO98/52905, JP1989-272551A (JP-H1-272551A), JP1994-16616A (JP-H6-16616A), JP1995-110469A (JP-H7-110469A), JP1999-80081A (JP-H11-80081A), and JP2001-328973A.

In the present invention, from the viewpoint of further improving the diffraction efficiency of the prepared optical element, it is preferable that the rod-like liquid crystal compound is a compound represented by Formula (I).

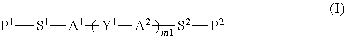

In Formula (I), P¹ and P² each independently represent a hydrogen atom or a substituent.

In addition, S¹ and S² each independently represent a single bond or a divalent linking group.

In addition, A¹ and A² each independently represent a non-aromatic ring, an aromatic ring, or an aromatic heterocycle which may have a substituent. In a case where a plurality of A²'s are present, the plurality of A²'s may be the same as or different from each other.

In addition, Y¹ represents —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, —OCH₂CH₂O—, —SCH₂CH₂S—, or a single bond. In a case where a plurality of Y's are present, the plurality of Y's may be the same as or different from each other.

In addition, m1 represents an integer of 1 to 12.

Examples of the substituent in one aspect of P¹ and P² in Formula (I) include an alkyl group, an alkoxy group, an alkylcarbonyl group, an alkoxycarbonyl group, an alkylcarbonyloxy group, an alkylamino group, a dialkylamino group, an alkylamido group, an alkenyl group, an alkynyl group, a halogen atom, a cyano group, a nitro group, an alkylthiol group, an N-alkyl carbamate group, and a polymerizable group. In particular, an alkyl group, an alkoxy group, or a polymerizable group is preferable.

As the alkyl group that is the preferable example of the substituent, a linear, branched, or cyclic alkyl group having 1 to 18 carbon atoms is preferable, and an alkyl group having 1 to 12 carbon atoms (for example, a methyl group, an ethyl group, a propyl group, an isopropyl group, an n-butyl group, an isobutyl group, a sec-butyl group, a t-butyl group, a hexylene group, a heptyl group, a dodecyl group, or a cyclohexyl group) is more preferable.

As the alkoxy group that is the preferable example of the substituent, an alkoxy group having 1 to 18 carbon atoms is preferable, an alkoxy group having 1 to 12 carbon atoms (for example, a methoxy group, an ethoxy group, an n-butoxy group, or a methoxyethoxy group) is more preferable.

The polymerizable group that is the preferable example of the substituent is not particularly limited, and a radically polymerizable or cationically polymerizable group is preferable.

As the radically polymerizable group, a radically polymerizable group that is generally well-known can be used, and preferable examples thereof include an acryloyloxy group and a methacryloyloxy group. In this case, it is generally known that the polymerization rate of an acryloyloxy group is fast, and from the viewpoint of improving productivity, an acryloyloxy group is preferable. However, a methacryloyloxy group can also be preferably used as the polymerizable group.

As the cationically polymerizable group, a cationically polymerizable group that is generally known can be used, and specific examples thereof include an alicyclic ether group, a cyclic acetal group, a cyclic lactone group, a cyclic thioether group, a spiro ortho ester group, and a vinyloxy group. In particular, an alicyclic ether group or a vinyloxy group is preferable, and an epoxy group, an oxetanyl group, or a vinyloxy group is more preferable.

Examples of the more preferable polymerizable group include a polymerizable group represented by any one of Formulas (P-1) to (P-20). In particular, a polymerizable group represented by any one of Formulas (P-1), (P-2), (P-7), and (P-12) is preferable.

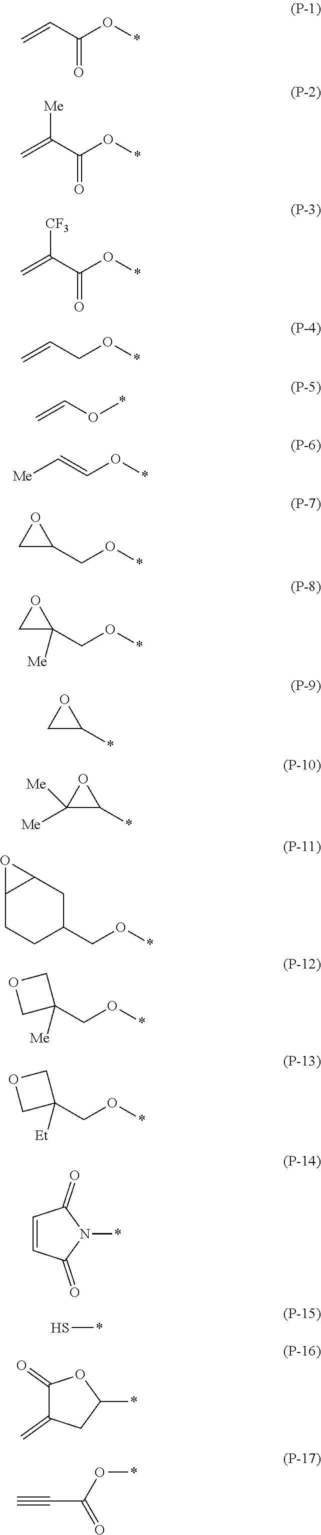

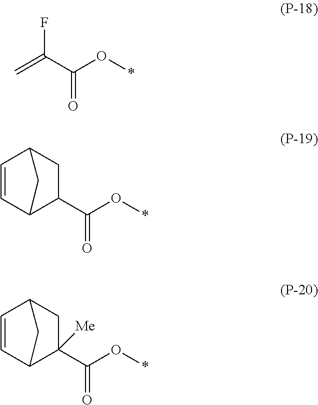

In the present invention, from the viewpoint of improving the durability of the prepared optical element, it is preferable that at least one of P¹ or P² represents a polymerizable group, and it is more preferable that both of P¹ and P² represent a polymerizable group.

Examples of the divalent linking group in one aspect of S¹ and S² in Formula (I) include —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, a divalent hydrocarbon group (for example, a saturated hydrocarbon group such as an alkylene group which may have a substituent, an alkenylene group, alkynylene group, or an arylene group), and a group including a combination thereof.

Among these, a divalent hydrocarbon group is preferable, and a divalent hydrocarbon group having 1 to 20 carbon atoms which may have a substituent is more preferable.

Here, one or more methylene groups in the hydrocarbon group may be each independently substituted with —O— or —C(═O)—. One methylene group may be substituted with —O— and a methylene group adjacent thereto may be substituted with —C(═O)— to form an ester group.

In addition, the number of carbon atoms in the divalent hydrocarbon group is preferably 1 to 20, more preferably 1 to 10, and still more preferably 1 to 5.

The divalent hydrocarbon group may be linear or branched and may form a cyclic structure.

Examples of the substituent which may be included in the divalent hydrocarbon group are the same as those of the substituent in one aspect of P¹ and P² in Formula (I). In particular, an alkyl group, an alkoxy group, an alkoxycarbonyl group, an alkylcarbonyloxy group, or a halogen atom is preferable.

Examples of the non-aromatic ring in one aspect of A¹ and A² in Formula (I) include a cycloalkane ring.

Specific examples of the cycloalkane ring include a cyclohexane ring, a cyclopeptane ring, a cyclooctane ring, a cyclododecane ring, and a cyclodocosane ring.

Among these, a cyclohexane ring is preferable, a 1,4-cyclohexylene group is more preferable, and a trans-1,4-cyclohexylene group is still more preferable.

Examples of the aromatic ring in one aspect of A¹ and A² in Formula (I) include a benzene ring, a naphthalene ring, and an anthracene ring.

Among these, a benzene ring (for example, a 1,4-phenyl group) or a naphthalene ring is preferable.

In addition, examples of the aromatic heterocycle in one aspect of A¹ and A² in Formula (I) include a furan ring, a pyrrole ring, a thiophene ring, an oxadiazole ring (1,3,4-oxadiazole), a thiadiazole ring (1,3,4-thiadiazole), a pyridine ring, a pyrazine ring (1,4-thiazine), a pyrimidine ring (1,3-thiazine), a pyridazine ring (1,2-thiazine), a thiazole ring, a benzothiazole ring, and a phenanthroline ring.

Among these, a thiophene ring, an oxadiazole ring, a thiadiazole ring, a pyridine ring, or a pyrimidine ring is preferable.

Examples of the substituent which may be included in A¹ and A² in Formula (I) are the same as those of the substituent in one aspect of P¹ and P² in Formula (I). In particular, an alkyl group, an alkoxy group, an alkoxycarbonyl group, an alkylcarbonyloxy group, or a halogen atom is preferable.

As the alkyl group, a linear, branched, or cyclic alkyl group having 1 to 18 carbon atoms is preferable, an alkyl group having 1 to 8 carbon atoms (for example, a methyl group, an ethyl group, a propyl group, an isopropyl group, an n-butyl group, an isobutyl group, a sec-butyl group, a t-butyl group, or a cyclohexyl group) is more preferable, an alkyl group having 1 to 4 carbon atoms is still more preferable, and a methyl group or an ethyl group is still more preferable.

As the alkoxy group, an alkoxy group having 1 to 18 carbon atoms is preferable, an alkoxy group having 1 to 8 carbon atoms (for example, a methoxy group, an ethoxy group, an n-butoxy group, or a methoxyethoxy group) is more preferable, an alkoxy group having 1 to 4 carbon atoms is still more preferable, and a methoxy group or an ethoxy group is still more preferable.

Examples of the alkoxycarbonyl group include a group where an oxycarbonyl group (—O—CO— group) is bonded to the above-described alkyl group. In particular, a methoxycarbonyl group, an ethoxycarbonyl group, an n-propoxycarbonyl group, or an isopropoxycarbonyl group is preferable, and a methoxycarbonyl group is more preferable.

Examples of the alkylcarbonyloxy group include a group where a carbonyloxy group (—CO—O—group) is bonded to the above-described alkyl group. In particular, a methylcarbonyloxy group, an ethylcarbonyloxy group, an n-propylcarbonyloxy group, or an isopropylcarbonyloxy group is preferable, and a methylcarbonyloxy group is more preferable.

Examples of the halogen atom include a fluorine atom, a chlorine atom, a bromine atom, and an iodine atom. Among these, a fluorine atom or a chlorine atom is preferable.

In Formula (I), as described above, Y¹ represents —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, —OCH₂CH₂O—, —SCH₂CH₂S—, or a single bond.

Among these, any one of —O—, —CO—, —COO—, —OCO—, —C≡C—, or a single bond is preferable.

In the present invention, from the viewpoint of further improving the diffraction efficiency of the prepared optical element, it is preferable that at least one Y¹ in Formula (I) represents —C≡C—. In a case where m1 represents 1, at least one Y¹ represents one Y¹, and in a case where m1 represents an integer of 2 to 12, at least one Y¹ represents at least one Y¹ among the plurality of Y¹'s.

In Formula (I), as described above, m1 represents an integer of 1 to 12, preferably an integer of 1 to 8, and more preferably an integer of 1 to 5.

Specific examples of the rod-like liquid crystal compound include rod-like liquid crystal compounds (I-1) to (I-24) shown below.

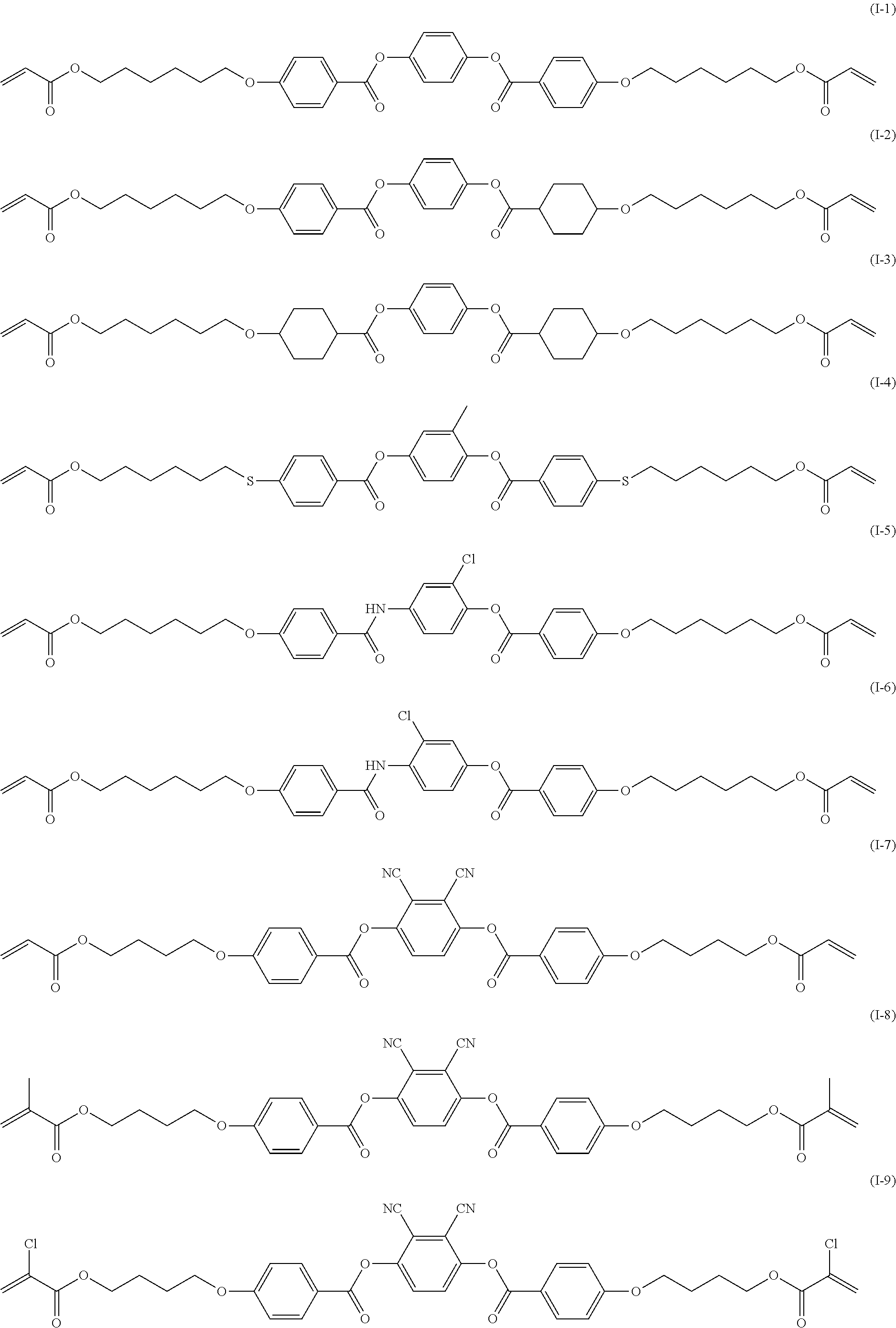

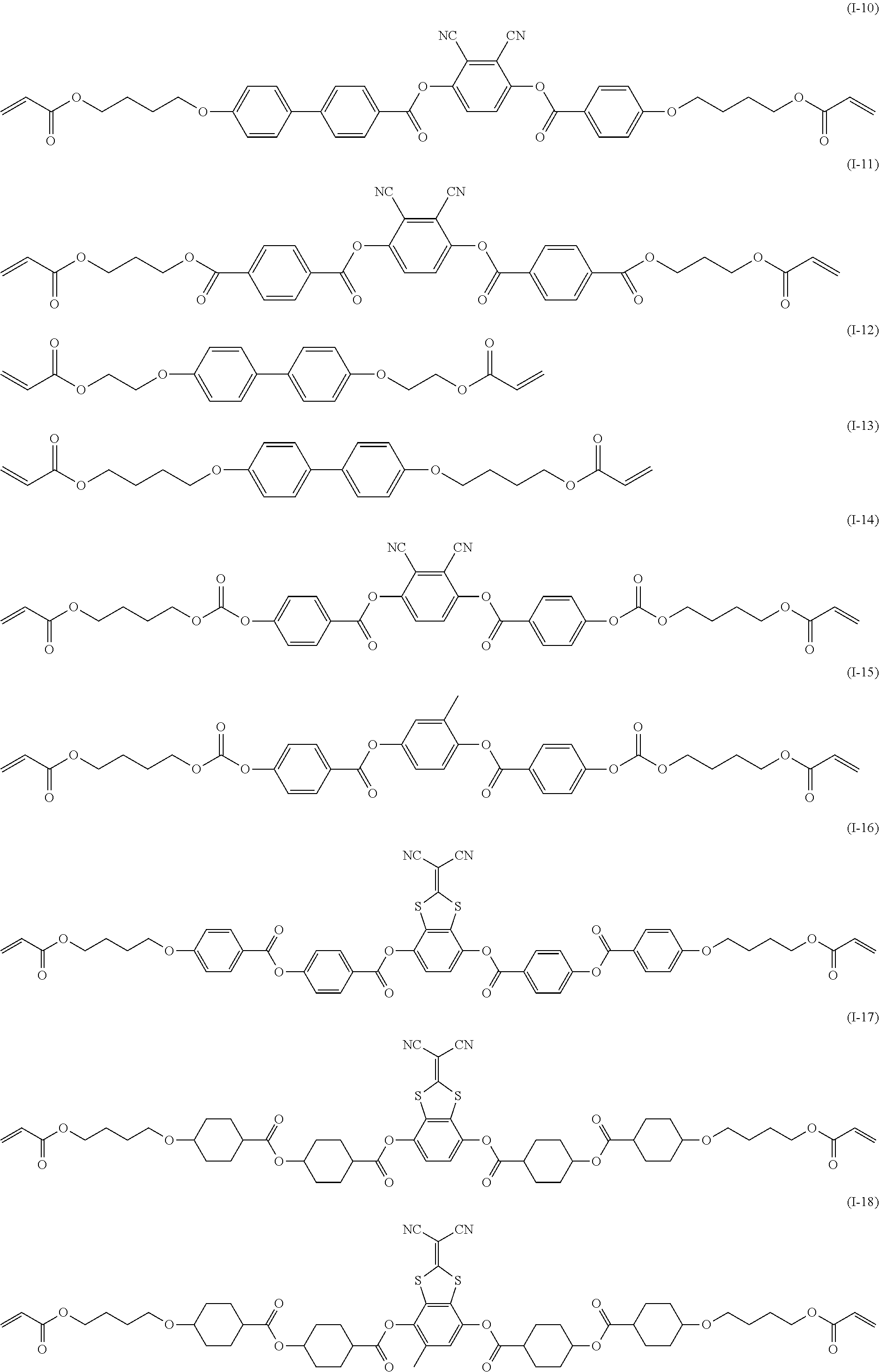

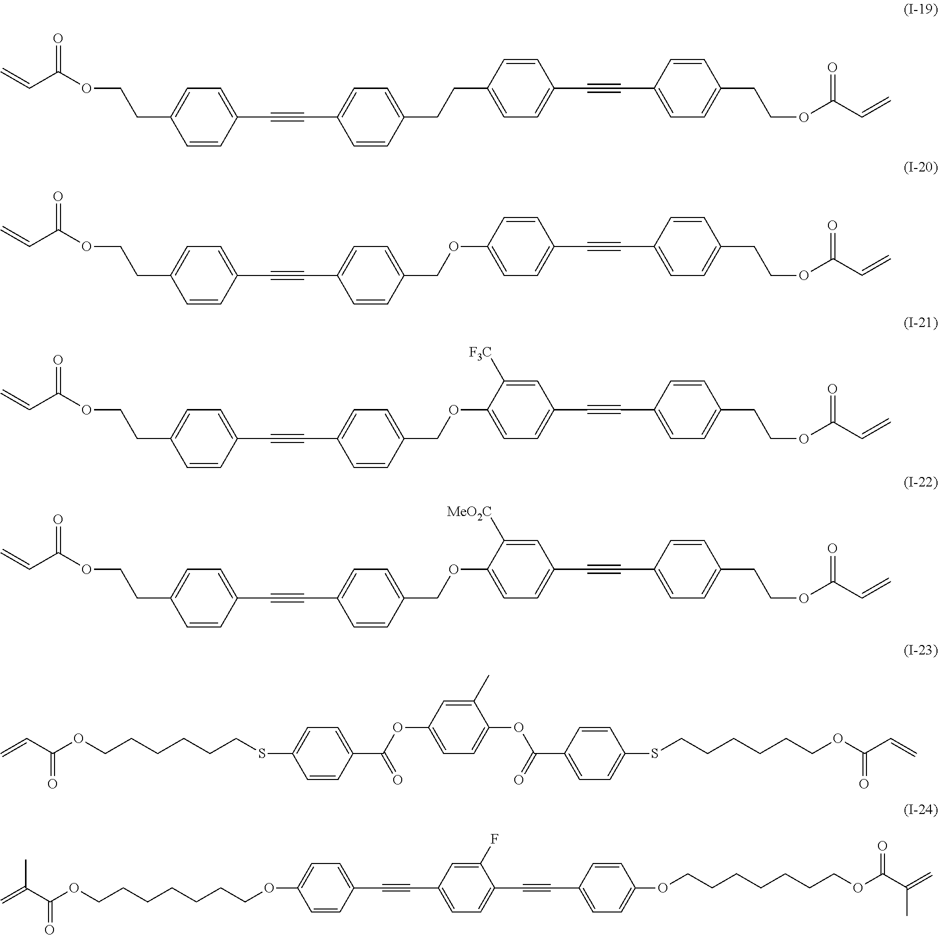

In the present invention, the content of the rod-like liquid crystal compound is preferably 50 to 95 mass %, more preferably 60 to 90 mass %, and still more preferably 70 to 85 mass % with respect to the total mass of the solid content of the liquid crystal composition (the total mass of the components other than a solvent).

<Disk-Like Liquid Crystal Compound>

Specific examples of the disk-like liquid crystal compound include compounds described in the documents (C. Destrade et al., Mol. Cryst. Liq. Cryst., vol. 71, page 111 (1981); The Chemical Society of Japan, Kagaku-Sosetsu, No 22, Chemistry of Liquid crystal, Chapter 5 and Chapter 10, section 2 (1994); B. Kohne et al., Angew. Chem. Soc. Chem. Soc., page 1794 (1985); J. Zhang et al., J. Am. Chem. Soc., vol. 116, page 2655 (1994); JP2007-108732A; and JP2010-244038A. The polymerization of the disk-like liquid crystal compound is described in JP1996-27284A (JP-H8-27284A).

In the present invention, from the viewpoint of further improving the diffraction efficiency of the prepared optical element, it is preferable that the disk-like liquid crystal compound is a compound represented by Formula (II).

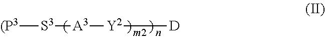

In Formula (II), P³ represents a hydrogen atom or a substituent. A plurality of P³'s may be the same as or different from each other.

In addition, S³ represents a single bond or a divalent linking group. A plurality of S³'s may be the same as or different from each other.

In addition, A³ represent a non-aromatic ring, an aromatic ring, or an aromatic heterocycle which may have a substituent. A plurality of A³'s may be the same as or different from each other.

In addition, Y² represents —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, —OCH₂CH₂O—, —SCH₂CH₂S—, or a single bond. A plurality of Y²'s may be the same as or different from each other.

In addition, m2 represents an integer of 0 to 5.

In addition, n represents an integer of 3 to 20.

In addition, D represents an n-valent disk-like core.

Examples of the substituent in one aspect of P³ in Formula (II) are the same as those of the substituent in one aspect of P¹ and P² in Formula (I), and a preferable aspect thereof is also the same.

In the present invention, from the viewpoint of improving the durability of the prepared optical element, it is preferable that at least one of the plurality of P³'s represents a polymerizable group, and it is more preferable that all of P³'s represent a polymerizable group.

Examples of the divalent linking group in one aspect of S³ in Formula (II) are the same as those of the divalent linking group in one aspect of S¹ and S² in Formula (I), and a preferable aspect thereof is also the same.

Examples of “a non-aromatic ring, an aromatic ring, or an aromatic heterocycle which may have a substituent” represented by A³ in Formula (II) include those of “a non-aromatic ring, an aromatic ring, or an aromatic heterocycle which may have a substituent” represented by A¹ and A² in Formula (I), and a preferable aspect thereof is also the same.

Examples of the Y² in Formula (II) are the same as those of the Y¹ in Formula (I), and a preferable aspect thereof is also the same.

In Formula (II), as described above, m2 represents an integer of 0 to 5, preferably an integer of 0 to 4, and more preferably an integer of 0 to 3.

In Formula (II), as described above, n represents an integer of 3 to 20, preferably an integer of 3 to 15, and more preferably an integer of 3 to 10.

In Formula (II), as described above, D represents an n-valent disk-like core.

Here, the disk-like core is not particularly limited, and examples thereof include structures represented by Formulas (II-1c) to (II-20c). In the following formulas, * represents a bonding position to a group represented by —(Y²-A³)ₘ₂-S³-P³.

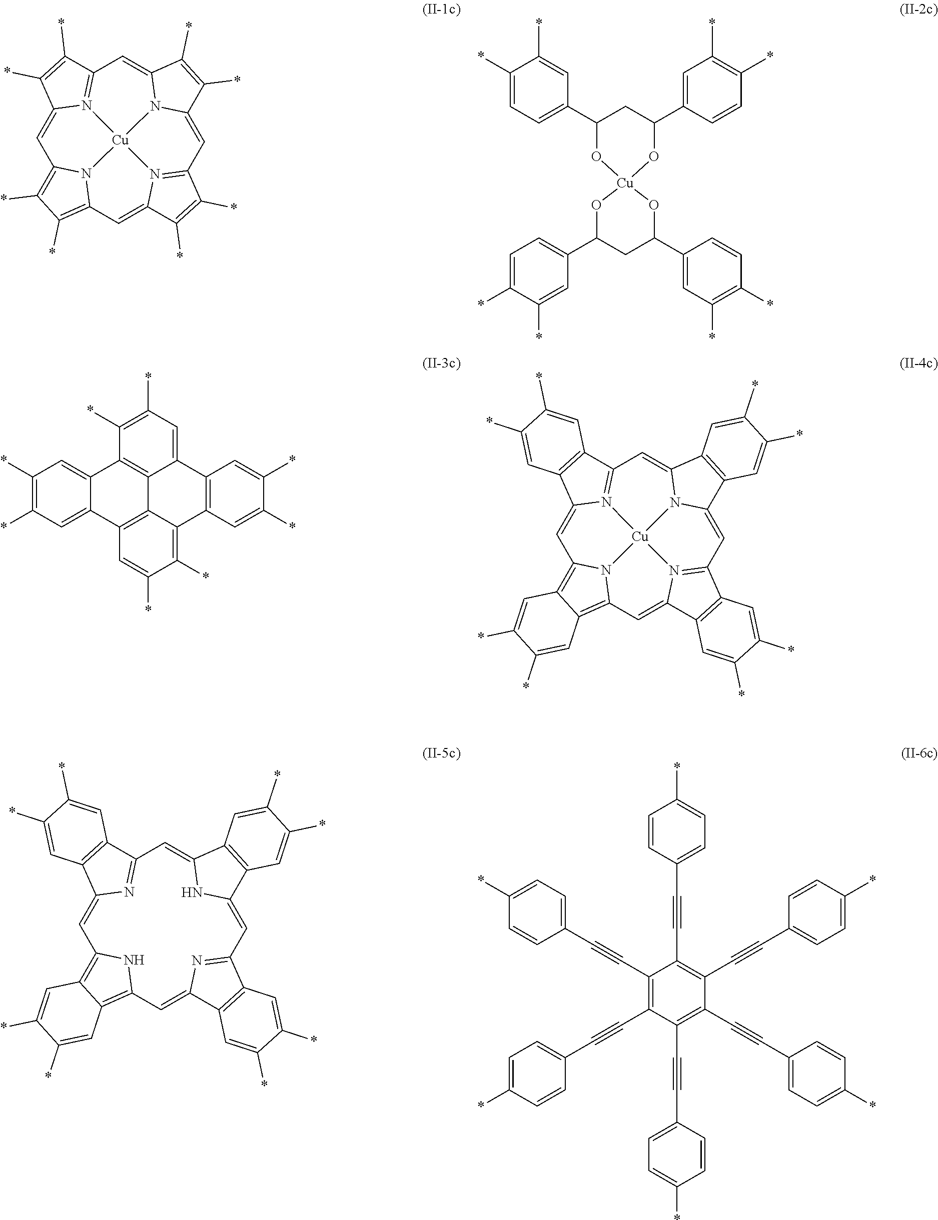

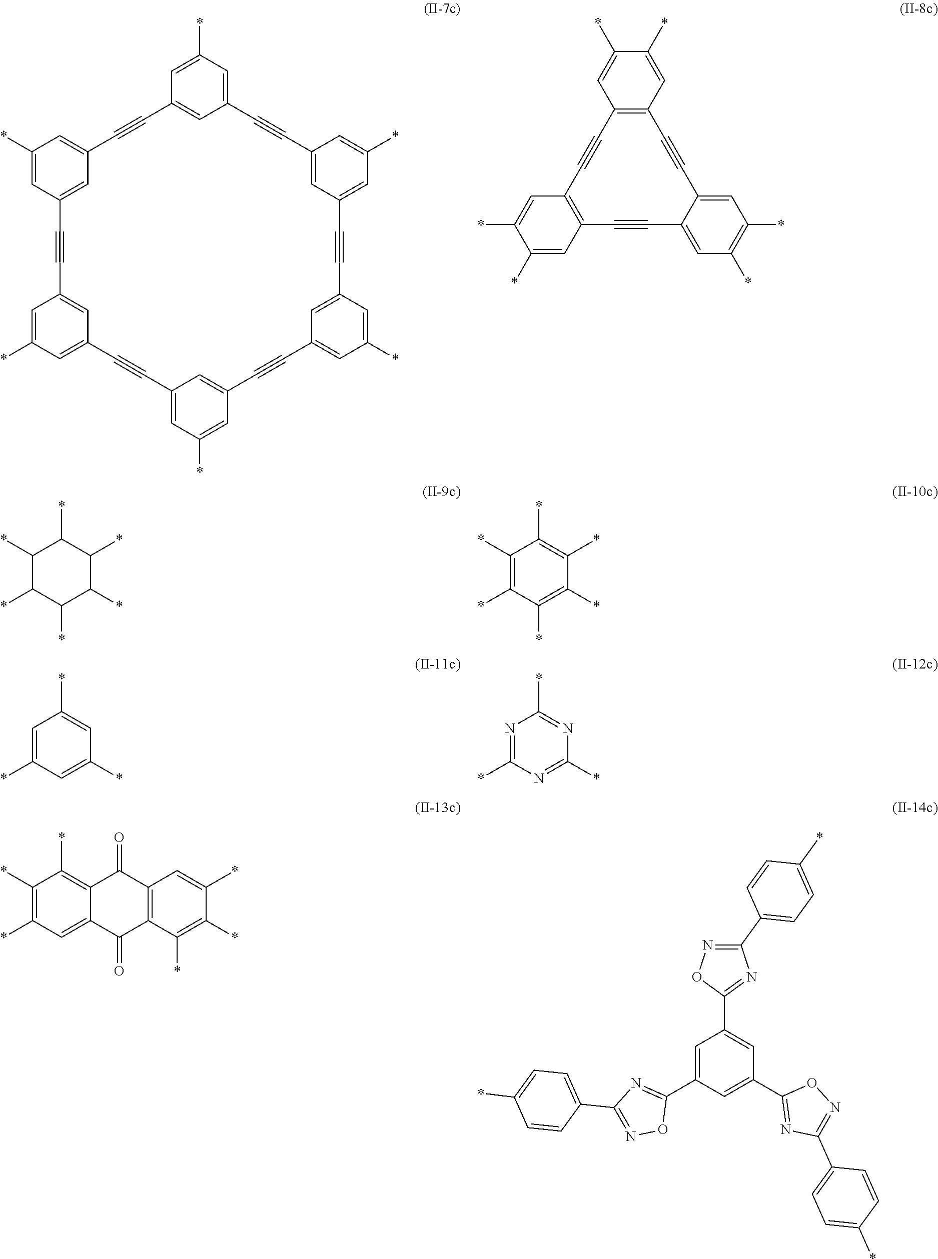

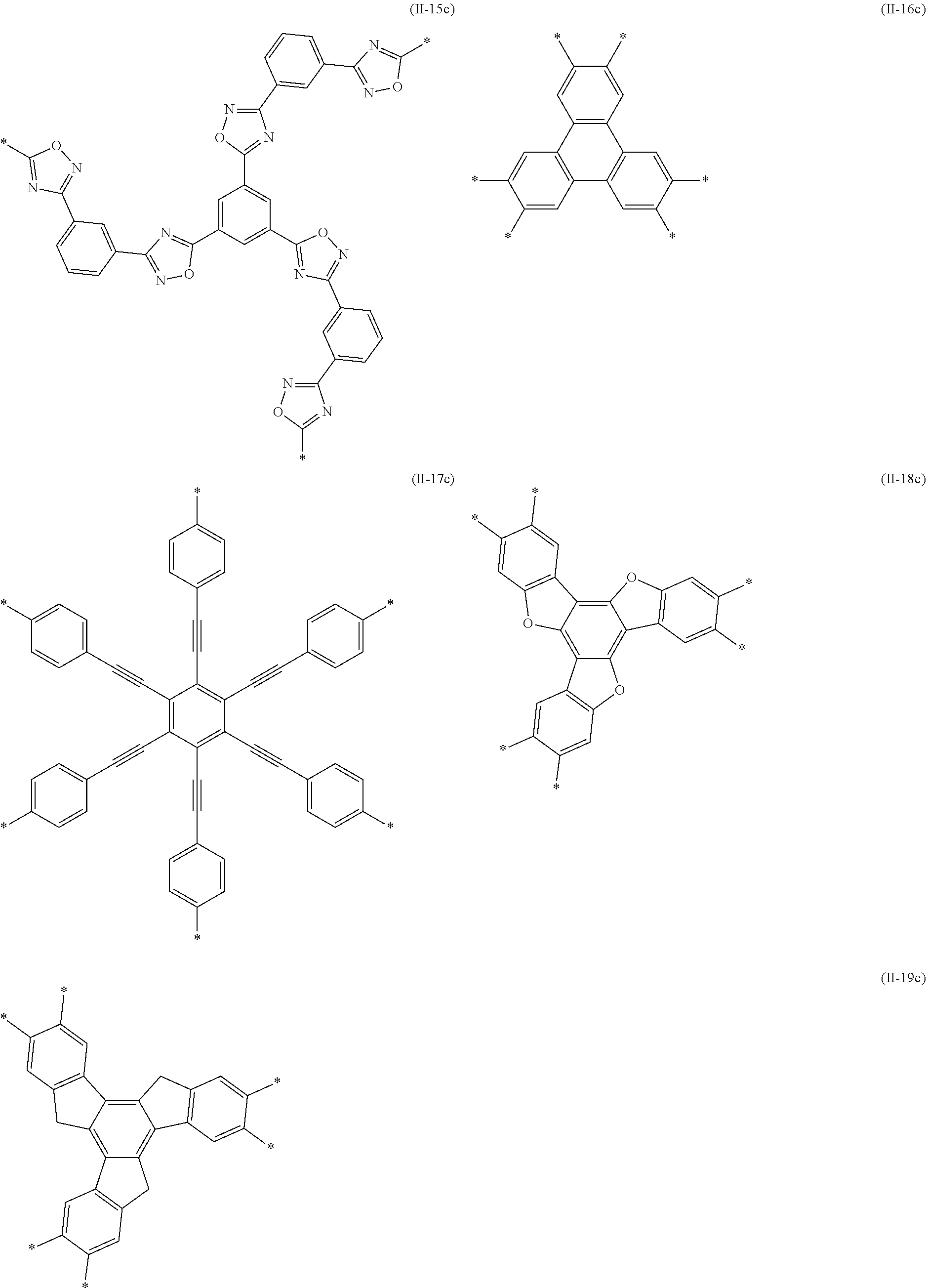 [SMILES: *c1nc(-c2cccc(-c3noc(-c4cc(-c5nc(-c6cccc(-c7noc(*)n7)c6)no5)cc(-c5nc(-c6cccc(-c7noc(*)n7)c6)no5)c4)n3)c2)no1 ; *c1cc2c3cc(*)c(*)cc3c3cc(*)c(*)cc3c2cc1* ; *c1ccc(C#Cc2c(C#Cc3ccc(*)cc3)c(C#Cc3ccc(*)cc3)c(C#Cc3ccc(*)cc3)c(C#Cc3ccc(*)cc3)c2C#Cc2ccc(*)cc2)cc1 ; *c1cc2oc3c(c2cc1*)c1oc2cc(*)c(*)cc2c1c1oc2cc(*)c(*)cc2c31 ; *c1cc2c(cc1*)-c1c(c3c(c4c1Cc1cc(*)c(*)cc1-4)Cc1cc(*)c(*)cc1-3)C2]

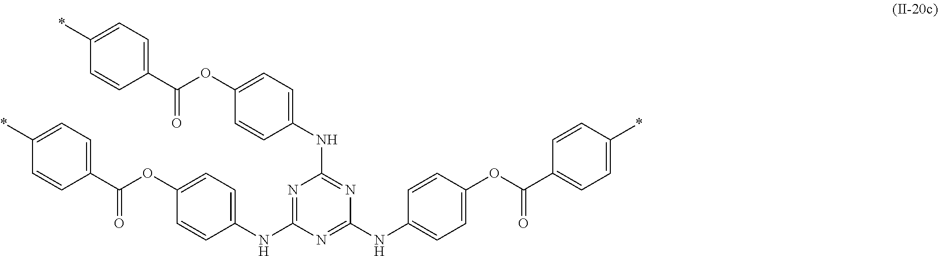 [SMILES: *c1ccc(C(=O)Oc2ccc(Nc3nc(Nc4ccc(OC(=O)c5ccc(*)cc5)cc4)nc(Nc4ccc(OC(=O)c5ccc(*)cc5)cc4)n3)cc2)cc1]

Specific examples of the disk-like liquid crystal compound include disk-like liquid crystal compounds (II-1) to (II-20) shown below. In the following structural formulas, structures represented Y are shown below.

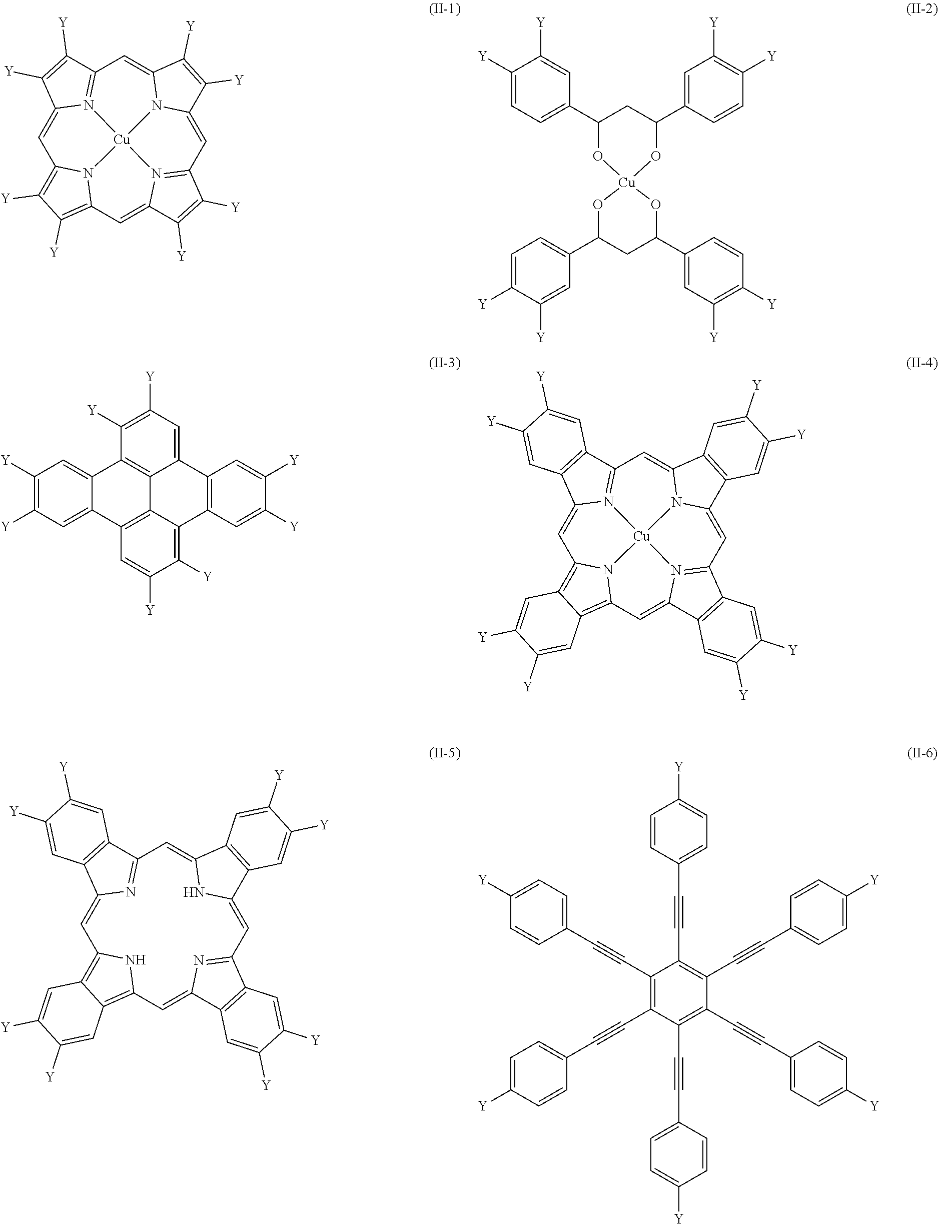

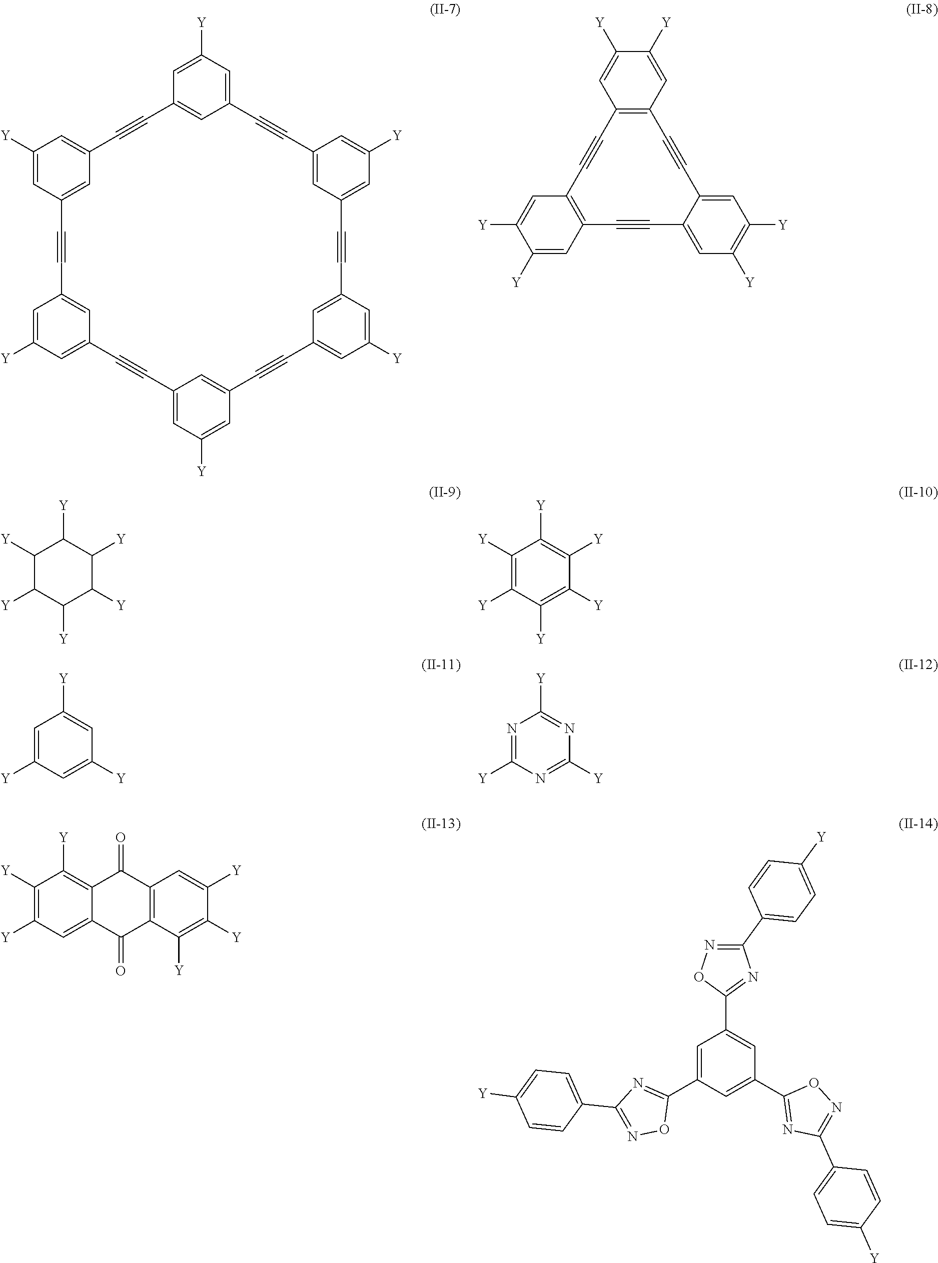

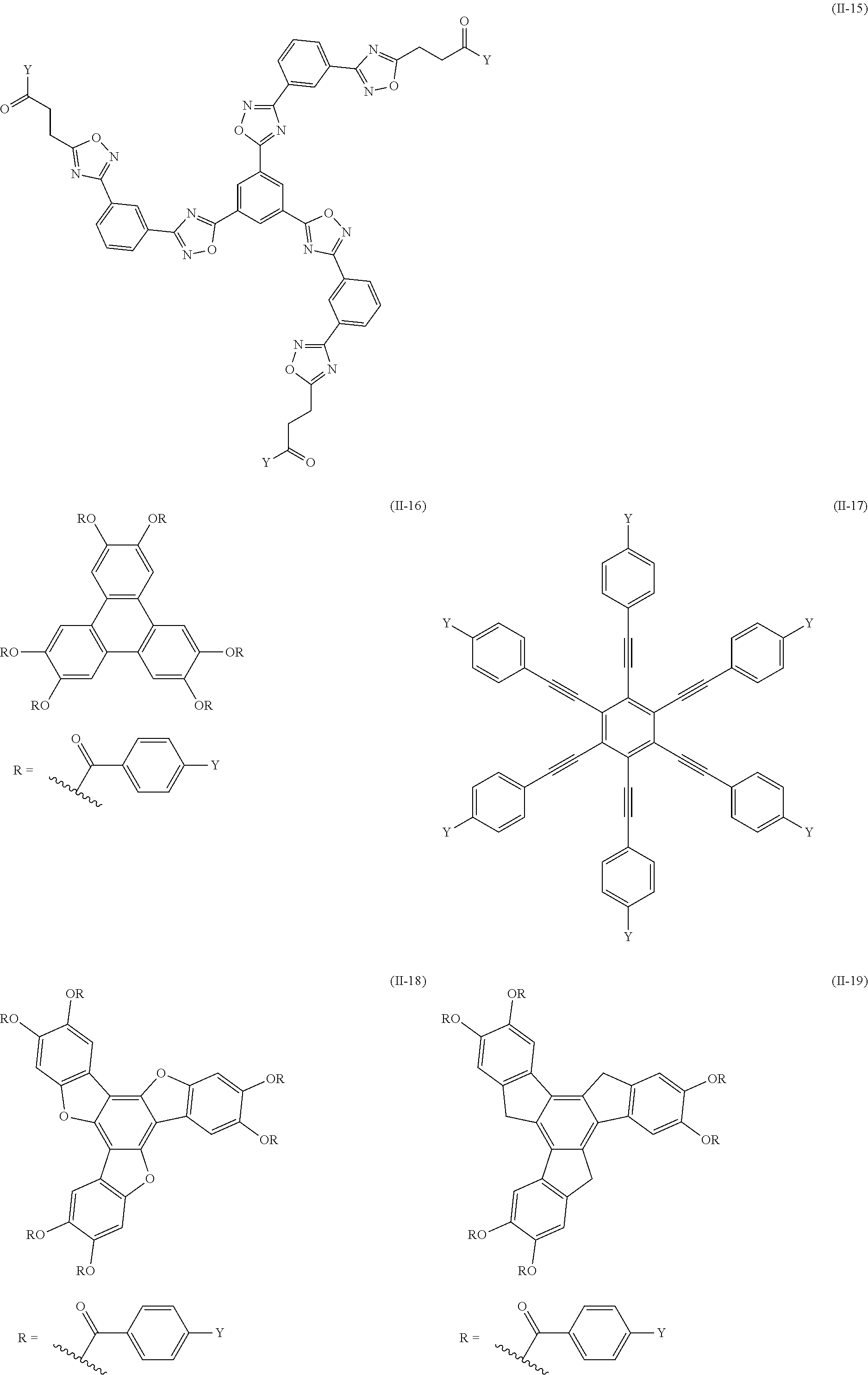

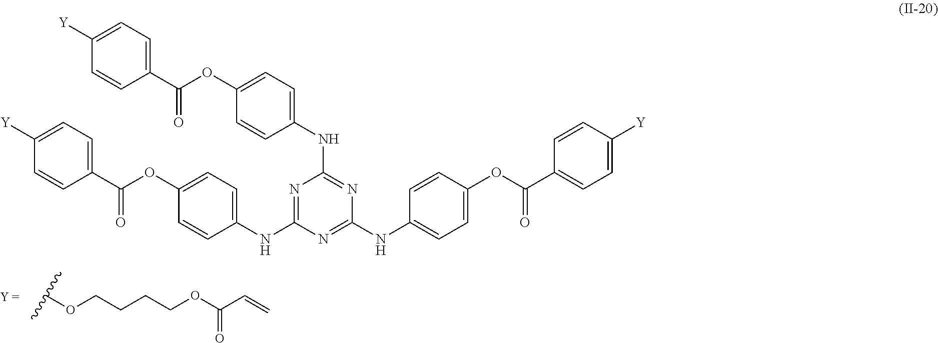

In the present invention, from the viewpoint of further improving the diffraction efficiency of the prepared optical element, the content of the disk-like liquid crystal compound in the liquid crystal composition is preferably 50 mass % or less, more preferably 5 to 25 mass %, and still more preferably 5 to 20 mass % with respect to a total mass of the rod-like liquid crystal compound and the disk-like liquid crystal compound in the liquid crystal composition.

In addition, in a case where the content of the disk-like liquid crystal compound is in the above-described range, the ratio (K22/K11) between the twist elastic constant (K22) and the splay elastic constant (K11) of the liquid crystal composition is easily adjusted to be 0.7 or more.

[Surfactant]

The liquid crystal composition according to the embodiment of the present invention may include a surfactant.

It is preferable that the surfactant is a compound that can function as an alignment control agent contributing to the stable or rapid alignment of a cholesteric liquid crystalline phase. Examples of the surfactant include a silicone-based surfactant and a fluorine-based surfactant. Among these, a fluorine-based surfactant is preferable.

Specific examples of the surfactant include compounds described in paragraphs “0082” to “0090” of JP2014-119605A, compounds described in paragraphs “0031” to “0034” of JP2012-203237A, exemplary compounds described in paragraphs “0092” and “0093” of JP2005-99248A, exemplary compounds described in paragraphs “0076” to “0078” and paragraphs “0082” to “0085” of JP2002-129162A, and fluorine (meth)acrylate polymers described in paragraphs “0018” to “0043” of JP2007-272185A.

The surfactants may be used alone or in combination of two or more kinds.

As the fluorine-based surfactant, a compound described in paragraphs “0082” to “0090” of JP2014-119605A is preferable.

The addition amount of any surfactant is preferably 0.01 to 10 mass %, more preferably 0.01 to 5 mass %, and still more preferably 0.02 to 1 mass % with respect to the mass of the rod-like liquid crystal compound.

[Chiral Agent (Optically Active Compound)]

The liquid crystal composition according to the embodiment of the present invention may include a chiral agent.

The chiral agent has a function of causing a helical structure of a cholesteric liquid crystalline phase to be formed. The chiral agent may be selected depending on the purpose because a helical twisted direction or a helical pitch derived from the compound varies.

The chiral agent is not particularly limited, and a well-known compound (for example, Liquid Crystal Device Handbook (No. 142 Committee of Japan Society for the Promotion of Science, 1989), Chapter 3, Article 4-3, chiral agent for twisted nematic (TN) or super twisted nematic (STN), p. 199), isosorbide, or an isomannide derivative can be used.

In general, the chiral agent includes an asymmetric carbon atom. However, an axially asymmetric compound or a planar asymmetric compound not having an asymmetric carbon atom can also be used as the chiral agent. Examples of the axially asymmetric compound or the planar asymmetric compound include binaphthyl, helicene, paracyclophane, and derivatives thereof. The chiral agent may include a polymerizable group. In a case where both the chiral agent and the liquid crystal compound have a polymerizable group, a polymer which includes a repeating unit derived from the polymerizable liquid crystal compound and a repeating unit derived from the chiral agent can be formed due to a polymerization reaction of a polymerizable chiral agent and the polymerizable liquid crystal compound. In this aspect, it is preferable that the polymerizable group in the polymerizable chiral agent is the same as the polymerizable group in the polymerizable liquid crystal compound. Accordingly, the polymerizable group of the chiral agent is preferably an unsaturated polymerizable group, an epoxy group, or an aziridinyl group, more preferably an unsaturated polymerizable group, and still more preferably an ethylenically unsaturated polymerizable group.

In addition, the chiral agent may be a liquid crystal compound.

In a case where the chiral agent includes a photoisomerization group, a pattern having a desired reflection wavelength corresponding to a luminescence wavelength can be formed by irradiation of an actinic ray or the like through a photomask after coating and alignment, which is preferable. As the photoisomerization group, an isomerization portion of a photochromic compound, an azo group, an azoxy group, or a cinnamoyl group is preferable. Specific examples of the compound include compounds described in JP2002-080478A, JP2002-080851A, JP2002-179668A, JP2002-179669A, JP2002-179670A, JP2002-179681A, JP2002-179682A, JP2002-338575A, JP2002-338668A, JP2003-313189A, and JP2003-313292A.

The content of any chiral agent is preferably 0.01% to 200 mol % and more preferably 1% to 30 mol % with respect to the content molar amount of the rod-like liquid crystal compound.

[Polymerization Initiator]

It is preferable that the liquid crystal composition according to the embodiment of the present invention includes a polymerization initiator. In an aspect where a polymerization reaction progresses with ultraviolet irradiation, it is preferable that the polymerization initiator is a photopolymerization initiator which can initiate a polymerization reaction with ultraviolet irradiation.

Examples of the photopolymerization initiator include an α-carbonyl compound (described in U.S. Pat. Nos. 2,367,661A and 2,367,670A), an acyloin ether (described in U.S. Pat. No. 2,448,828A), an α-hydrocarbon-substituted aromatic acyloin compound (described in U.S. Pat. No. 2,722,512A), a polynuclear quinone compound (described in U.S. Pat. Nos. 3,046,127A and 2,951,758A), a combination of a triarylimidazole dimer and p-aminophenyl ketone (described in U.S. Pat. No. 3,549,367A), an acridine compound and a phenazine compound (described in JP1985-105667A (JP-S60-105667A) and U.S. Pat. No. 4,239,850A), and an oxadiazole compound (described in U.S. Pat. No. 4,212,970A).

The content of any photopolymerization initiator is preferably 0.1 to 20 mass % and more preferably 0.5 to 12 mass % with respect to the mass of the rod-like liquid crystal compound.

[Crosslinking Agent]

In order to improve the film hardness after curing and to improve durability, the liquid crystal composition according to the embodiment of the present invention may optionally include a crosslinking agent. As the crosslinking agent, a curing agent which can perform curing with ultraviolet light, heat, moisture, or the like can be suitably used.

The crosslinking agent is not particularly limited and can be appropriately selected depending on the purpose. Examples of the crosslinking agent include: a polyfunctional acrylate compound such as trimethylol propane tri(meth)acrylate or pentaerythritol tri(meth)acrylate; an epoxy compound such as glycidyl (meth)acrylate or ethylene glycol diglycidyl ether; an aziridine compound such as 2,2-bis hydroxymethyl butanol-tris[3-(1-aziridinyl)propionate] or 4,4-bis(ethyleneiminocarbonylamino)diphenylmethane; an isocyanate compound such as hexamethylene diisocyanate or a biuret type isocyanate; a polyoxazoline compound having an oxazoline group at a side chain thereof, and an alkoxysilane compound such as vinyl trimethoxysilane or N-(2-aminoethyl)-3-aminopropyltrimethoxysilane. In addition, depending on the reactivity of the crosslinking agent, a well-known catalyst can be used, and not only film hardness and durability but also productivity can be improved. The organic solvents may be used alone or in combination of two or more kinds.

The content of any crosslinking agent is preferably 3% to 20 mass % and more preferably 5% to 15 mass % with respect to the solid content mass of the liquid crystal composition. Even in a case where the content of the crosslinking agent is in the above-described range, the durability of the prepared optical element is improved.

[Other Additives]

Optionally, a polymerization inhibitor, an antioxidant, an ultraviolet absorber, a light stabilizer, a coloring material, metal oxide fine particles, or the like can be added to the liquid crystal composition according to the embodiment of the present invention in a range where optical performance and the like do not deteriorate.

It is preferable that the liquid crystal composition according to the embodiment of the present invention is used as a liquid during the formation of the optically-anisotropic layer.

The liquid crystal composition may include a solvent. The solvent is not particularly limited and can be appropriately selected depending on the purpose. An organic solvent is preferable.

Examples of the organic solvent include a ketone, an alkyl halide, an amide, a sulfoxide, a heterocyclic compound, a hydrocarbon, an ester, and an ether. The organic solvents may be used alone or in combination of two or more kinds. Among these, a ketone is preferable in consideration of an environmental burden.

In the liquid crystal composition according to the embodiment of the present invention, from the viewpoint of further improving the diffraction efficiency of the prepared optical element, a difference Δn₅₅₀ in refractive index generated by refractive index anisotropy is preferably 0.2 or more, more preferably 0.25 or more, and still more preferably 0.25 or more and 0.50 or less.

Here, the difference Δn₅₅₀ in refractive index refers to a value calculated by applying the liquid crystal composition to a support with an alignment film for retardation measurement that is prepared separately, aligning a director (optical axis) of the liquid crystal compound to be parallel to a surface of the support, irradiating the liquid crystal compound with ultraviolet light for immobilization to obtain a liquid crystal immobilized layer (cured layer), and measuring the retardation value and the film thickness of the liquid crystal immobilized layer. Δn₅₅₀ can be calculated by dividing the retardation value by the film thickness.

In addition, the retardation value at a wavelength of 550 nm is measured using Axoscan (manufactured by Axometrix Inc.), and the film thickness is measured using a scanning electron microscope (SEM).

In the liquid crystal composition according to the embodiment of the present invention, from the viewpoint of the workability of preparing the optical element, a phase transition temperature between a liquid crystal phase and an isotropic phase is preferably 50° C. or higher, more preferably 70° C. or higher, and still more preferably 70° C. or higher and 400° C. or lower.

[Optical Element]

The optical element according to the embodiment of the present invention is an optically-anisotropic layer that is formed of a liquid crystal composition including a liquid crystal compound.

In addition, the liquid crystal composition includes a rod-like liquid crystal compound and a disk-like liquid crystal compound.

In addition, the optically-anisotropic layer has a liquid crystal alignment pattern in which a direction of an optical axis derived from the liquid crystal compound in the liquid crystal composition changes while continuously rotating in at least one in-plane direction.

Here, the optical axis of the liquid crystal compound refers to a major axis direction of a liquid crystal molecule in the rod-like liquid crystal compound, and refers to a direction orthogonal to a disc plane in the disk-like liquid crystal compound.

In the present invention, from the viewpoint of further improving the diffraction efficiency, it is preferable that the liquid crystal composition used for forming the optically-anisotropic layer is the liquid crystal composition according to the embodiment of the present invention.

Hereinafter, the optical element according to the present invention will be described in detail based on preferable embodiments shown in the accompanying drawings.

In the following description, the liquid crystal composition including the rod-like liquid crystal compound and the disk-like liquid crystal compound is abbreviated as “the liquid crystal composition according to the embodiment of the present invention”.

In addition, in the accompanying drawings, regarding the liquid crystal compounds, the description of the disk-like liquid crystal compound is not shown, and the description of only the rod-like liquid crystal compound is shown.

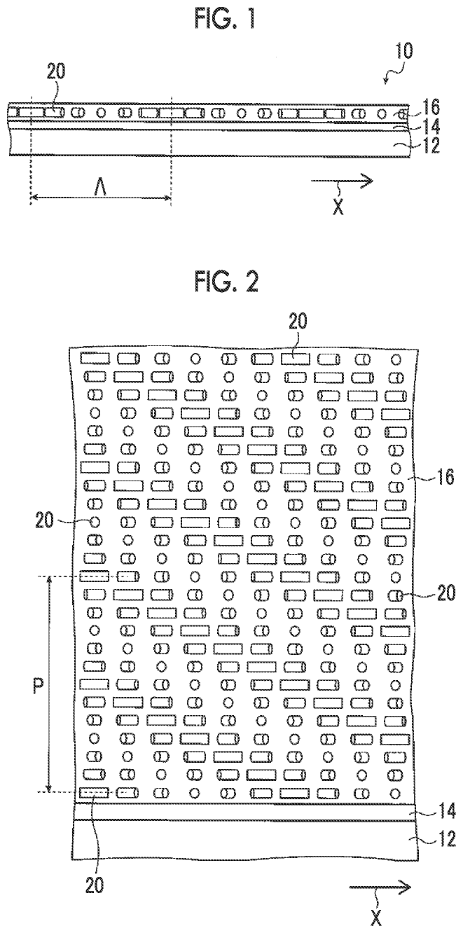

FIG. 1 is a diagram conceptually showing an example of the optical element according to the embodiment of the present invention.

As shown in FIG. 1, an optical element 10 includes a support 12, a photo-alignment film 14, and a cholesteric liquid crystal layer 16 as the optically-anisotropic layer that is formed of the above-described liquid crystal composition according to the embodiment of the present invention. The cholesteric liquid crystal layer 16 is a layer obtained by immobilizing a cholesteric liquid crystalline phase.

The optical element 10 in the example shown in the drawing includes the support 12, the photo-alignment film 14, and the cholesteric liquid crystal layer 16. However, the present invention is not limited to this configuration.

That is, the optical element according to the embodiment of the present invention may include only the photo-alignment film 14 and the cholesteric liquid crystal layer 16 (optically-anisotropic layer) by peeling off the support 12 after forming the photo-alignment film 14 and the cholesteric liquid crystal layer 16 on one surface of the support 12.

[Support]

In the optical element 10, the support 12 supports the photo-alignment film 14 and the cholesteric liquid crystal layer 16.

As the support 12, various sheet-shaped materials (films or plate-shaped materials) can be used as long as they can support the photo-alignment film 14 and the cholesteric liquid crystal layer 16.

A transmittance of the support 12 with respect to corresponding light is preferably 50% or more, more preferably 70% or more, and still more preferably 85% or more.

The thickness of the support 12 is not particularly limited and may be appropriately set depending on the use of the optical element 10, a material for forming the support 12, and the like in a range where the photo-alignment film 14 and the cholesteric liquid crystal layer can be supported.

The thickness of the support 12 is preferably 1 to 1000 μm, more preferably 3 to 250 μm, and still more preferably 5 to 150 μm.

The support 12 may have a monolayer structure or a multi-layer structure.

In a case where the support 12 has a monolayer structure, examples thereof include supports 12 formed of glass, triacetyl cellulose (TAC), polyethylene terephthalate (PET), polycarbonates, polyvinyl chloride, acryl, polyolefin, and the like. In a case where the support 12 has a multi-layer structure, examples thereof include a support including: one of the above-described supports having a monolayer structure that is provided as a substrate; and another layer that is provided on a surface of the substrate.

[Photo-Alignment Film]

In the optical element 10, the photo-alignment film 14 is disposed on a surface of the support 12.

The photo-alignment film 14 is an alignment film for aligning a rod-like liquid crystal compound 20 (hereinafter, abbreviated as “liquid crystal compound 20”) in a predetermined liquid crystal alignment pattern during the formation of the cholesteric liquid crystal layer 16 of the optical element 10.

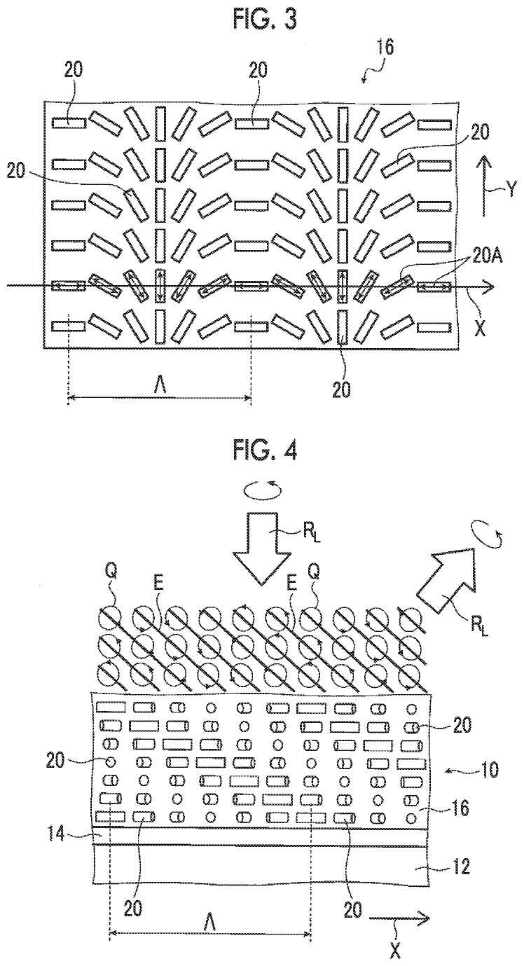

Although described below, in the optical element 10, the cholesteric liquid crystal layer 16 as the optically-anisotropic layer according to the embodiment of the present invention has a liquid crystal alignment pattern in which a direction of an optical axis 20A (refer to FIG. 3) derived from the liquid crystal compound 20 changes while continuously rotating in one in-plane direction. Accordingly, the photo-alignment film 14 is formed such that the cholesteric liquid crystal layer 16 can form the liquid crystal alignment pattern.

In the following description, “the direction of the optical axis 20A rotates” will also be simply referred to as “the optical axis 20A rotates”.

A material for forming the photo-alignment film 14 is not particularly limited. Examples of the material include a compound having a cinnamate group (a low-molecular weight compound, a monomer, or a polymer). In particular, from the viewpoint of further suppressing coloration, it is preferable that the photo-alignment film 14 includes a polymer having a cinnamate group.

Examples of a main chain that forms the polymer having a cinnamate group include poly(meth)acrylate, polyimide, polyurethane, polyamic acid, polymaleimide, polyether, polyvinyl ether, polyester, polyvinyl ester, a polystyrene derivative, polysiloxane, a cycloolefin polymer, an epoxy polymer, and a copolymer thereof.

In addition, examples of the monomer having a cinnamate group include a monomer that gives a repeating unit forming the polymer.

It is preferable that the polymer having a cinnamate group is liquid crystalline. Due to the liquid crystallinity, the alignment degree of the cinnamate group is improved, and thus the cholesteric liquid crystal layer is likely to be aligned. In addition, the diffraction efficiency of the optical element is further improved.

Examples of the polymer that is liquid crystalline include a biphenyl group, a terphenyl group, a naphthalene group, a phenylbenzoate group, and an azobenzene group that are widely used as a mesogen component of a liquid crystal polymer, and a polymer having a substituent (mesogenic group) of a derivative thereof as a side chain and having a structure of acrylate, methacrylate, maleimide, N-phenylmaleimide, siloxane, or the like as the main chain.

The side chain having the mesogen component and the cinnamate group may be side chains that are independent from each other or may be included in the same side chain.

Examples of the polymer that is liquid crystalline without including the mesogen component include a polymer having a carboxyl group at a side chain terminal. This polymer is a material that develops a liquid crystal phase due to the formation of a dimer by a hydrogen bond of the carboxyl group at the side chain terminal.

The side chain having a carboxyl group at a terminal and the cinnamate group may be side chains that are independent from each other or may be included in the same side chain but are preferably side chains that are independent from each other.

Optionally, the polymer having a cinnamate group may further have a side chain having a polymerizable group or a crosslinkable group.

As the polymerizable group, a radically polymerizable group or a cationically polymerizable group is preferable, and a (meth)acrylate group, an epoxy group, or an oxetanyl group is more preferable.

A crosslinkable group refers to a moiety bonded to a crosslinking agent described below by light or heat. Although depending on the kind of the crosslinking agent, examples of a specific functional group that can be used, for example, in a case where an epoxy compound, a methylol compound, an isocyanate compound, or the like is used as the crosslinking agent include a hydroxy group, a carboxy group, a phenolic hydroxy group, a mercapto group, a glycidyl group, and an amide group. In particular, from the viewpoint of reactivity, an aliphatic hydroxy group is preferable, and a primary hydroxy group is more preferable.

Examples of the low-molecular weight compound having a cinnamate group include compounds having a cinnamate group among compounds described in paragraphs “0042” to “0053” of WO2016/002722A and paragraphs “0030” to “0051” of WO2015/056741A.

Examples of a polymer having a functional group that can react with the low-molecular weight compound to form a covalent bond include polymers described in paragraphs “0091” to “0134” of WO2016/002722A, polymers described in paragraphs “0045” to “0092” of WO2015/129890A, polymers described in paragraphs “0057” to “0087” of WO2015/030000A, polymers described in paragraphs “0051” to “0086” of WO2014/171376A, and polymers described in paragraphs “0042” to “0058” of WO2014/104320A.

It is preferable that the photo-alignment film 14 is formed of a composition for forming a photo-alignment film including the above-described material (for example, the polymer having a cinnamate group).

The composition for forming a photo-alignment film may include other components such as a crosslinking agent, a photopolymerization initiator, a surfactant, a solvent, a rheology adjuster, a pigment, a dye, a storage stabilizer, an anti-foaming agent, or an antioxidant.

The crosslinking agent may form a crosslinking structure by reaction with the compound having a cinnamate group or with the polymer having a functional group that can form a covalent bond by reaction with the above-described compound, or may form a separate crosslinking structure without reaction with the above-described compounds.

Examples of the crosslinking agent include a (meth)acrylate compound, an epoxy compound, a methylol compound, and an isocyanate compound.

In order to trigger or accelerate the reaction of the crosslinking agent, optionally, a radical initiator, an acid generator, or a base generator may also be used.

As the photopolymerization initiator, any one of general-purpose photopolymerization initiators that are generally known to form a uniform film by a small amount of light irradiation can be used. Specific examples of the photopolymerization initiator include an azonitrile-based photopolymerization initiator, an α-aminoketone-based photopolymerization initiator, an acetophenone-based photopolymerization initiator, a benzoin-based photopolymerization initiator, a benzophenone-based photopolymerization initiator, a thioxanthone-based photopolymerization initiator, a triazine-based photopolymerization initiator, a carbazole-based photopolymerization initiator, and an imidazole-based photopolymerization initiator.

The photopolymerization initiators may be used alone or in combination of two or more kinds.

As the surfactant, any one of general-purpose surfactants that are generally known to form a uniform film can be used. Examples of the surfactant include an anionic surfactant, a nonionic surfactant, a cationic surfactant, and an amphoteric surfactant.

The solvent is not particularly limited as long as it can dissolve each of the above-described components, and examples thereof include ethylene glycol monomethyl ether, ethylene glycol monoethyl ether, methyl cellosolve acetate, ethyl cellosolve acetate, diethylene glycol monomethyl ether, diethylene glycol monoethyl ether, propylene glycol, propylene glycol monomethyl ether, propylene glycol monomethyl ether acetate, propylene glycol propyl ether acetate, ethylene glycol dimethyl ether, propylene glycol dimethyl ether, toluene, xylene, methyl ethyl ketone, cyclopentanone, cyclohexanone, 2-butanone, 3-methyl-2-pentanone, 2-pentanone, 2-heptanone, γ-butyrolactone, ethyl 2-hydroxypropionate, ethyl 2-hydroxy-2-methylpropionate, ethyl ethoxyacetate, ethyl hydroxyacetate, methyl 2-hydroxy-3-methylbutanoate, methyl 3-methoxypropionate, ethyl 3-methoxypropionate, ethyl 3-ethoxypropionate, methyl 3-ethoxypropionate, methyl pyruvate, ethyl pyruvate, ethyl acetate, butyl acetate, ethyl lactate, butyl lactate, N,N-dimethylformamide, N,N-dimethylacetamide, and N-methyl pyrrolidone.

Examples of a method of manufacturing the photo-alignment film 14 include a method including: applying the composition for forming a photo-alignment film to a substrate; distilling off a solvent to form a film (photoalignment precursor film); irradiating the obtained film with light having anisotropy; and heating the film to induce liquid crystal alignment capability such that a photo-alignment film is manufactured.

Examples of a method of applying the composition for forming a photo-alignment film include a spin coating method, a bar coating method, a die coater method, a screen printing method, and a spray coater method.

In addition, light to be irradiated is not particularly limited as long as it is irradiated radiation capable of causing a chemical reaction to occur by irradiation of infrared light, visible light, ultraviolet light, an X-ray, a charged particle beam, or the like. Typically, the irradiated radiation is likely to have a wavelength of 200 to 500 nm.

In a case where the film is heated after the light irradiation, thermal polymerization progresses such that a photo-alignment film having high durability to light, heat, and the like can be obtained, which is preferable.

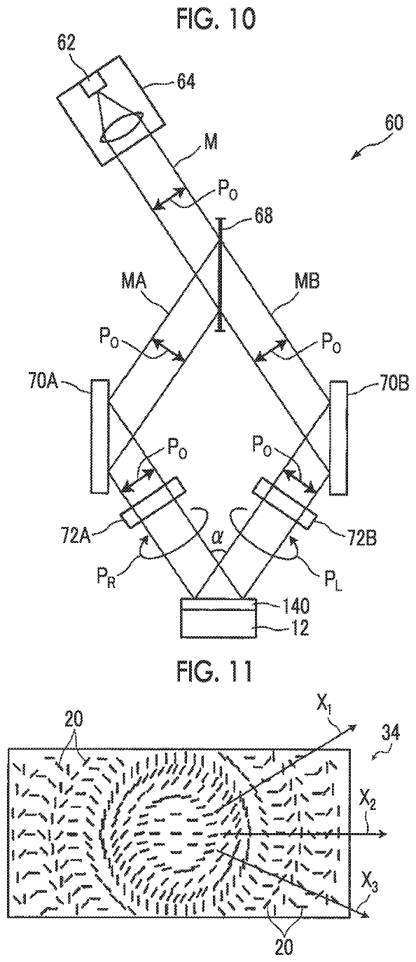

FIG. 10 conceptually shows an example of an exposure device that exposes a photoalignment precursor film 140 to form an alignment pattern.

An exposure device 60 shown in FIG. 10 includes: a light source 64 including a laser 62; a λ/2 plate 65 that changes a polarization direction of laser light M emitted from the laser 62; a polarization beam splitter 68 that splits the laser light M emitted from the laser 62 into two beams MA and MB; mirrors 70A and 70B that are disposed on optical paths of the split two beams MA and MB; and λ/4 plates 72A and 72B.

The light source 64 emits linearly polarized light P₀. The λ/4 plate 72A converts the linearly polarized light P₀ (beam MA) into right circularly polarized light P_{R}, and the λ/4 plate 72B converts the linearly polarized light P₀ (beam MB) into left circularly polarized light P_{L}.

The support 12 including the photoalignment precursor film 140 on which the alignment pattern is not yet formed is disposed at an exposed portion, the two beams MA and MB intersect and interfere each other on the photoalignment precursor film 140, and the photoalignment precursor film 140 is irradiated with and exposed to the interference light.

Due to the interference at this time, the polarization state of light with which the photoalignment precursor film 140 is irradiated periodically changes according to interference fringes. As a result, in the photo-alignment film 14, an alignment pattern in which the alignment state periodically changes can be obtained.

In the exposure device 60, by changing an intersecting angle α between the two beams MA and MB, the period of the alignment pattern can be adjusted. That is, by adjusting the intersecting angle α in the exposure device 60, in the alignment pattern in which the optical axis 20A derived from the liquid crystal compound 20 continuously rotates in the one in-plane direction, the length of the single period over which the optical axis 20A rotates by 180° in the one in-plane direction in which the optical axis 20A rotates can be adjusted.

By forming the cholesteric liquid crystal layer on the photo-alignment film 14 having the alignment pattern in which the alignment state periodically changes, as described below, the cholesteric liquid crystal layer having the liquid crystal alignment pattern in which the optical axis 20A derived from the liquid crystal compound 20 continuously rotates in the one in-plane direction can be formed.

In addition, by rotating the optical axes of the λ/4 plates 72A and 72B by 90°, respectively, the rotation direction of the optical axis 20A can be reversed.

[Cholesteric Liquid Crystal Layer]

In the optical element 10, the cholesteric liquid crystal layer 16 is formed on a surface of the photo-alignment film 14.

As described above, the cholesteric liquid crystal layer 16 is obtained by immobilizing a cholesteric liquid crystalline phase.

In FIG. 1, in order to simplify the drawing and to clarify the configuration of the optical element 10, as the cholesteric liquid crystal layer 16, only the liquid crystal compound 20 (liquid crystal compound molecule) on the surface of the photo-alignment film 14 and the surface of the cholesteric liquid crystal layer 16 is conceptually shown.

However, as conceptually shown in FIG. 2, the cholesteric liquid crystal layer 16 has a helical structure in which the liquid crystal compound 20 is helically turned and laminated as in a cholesteric liquid crystal layer obtained by immobilizing a typical cholesteric liquid crystalline phase. In the helical structure, a configuration in which the liquid crystal compound 20 is helically rotated once (rotated by 360) and laminated is set as one helical pitch, and plural pitches of the helically turned liquid crystal compound 20 are laminated. That is, the cholesteric liquid crystal layer 16 shown in FIG. 2 has a region where the direction of the optical axis derived from the liquid crystal compound 20 is twisted in the thickness direction and rotates.

As is well-known, the cholesteric liquid crystal layer obtained by immobilizing a cholesteric liquid crystalline phase has wavelength-selective reflectivity.

Although described below in detail, the selective reflection wavelength range of the cholesteric liquid crystal layer depends on the length (pitch P shown in FIG. 2) of one helical pitch described above in the thickness direction.

As described above, the cholesteric liquid crystal layer 16 is a cholesteric liquid crystal layer obtained by immobilizing a cholesteric liquid crystalline phase. That is, the cholesteric liquid crystal layer 16 is a layer formed of the liquid crystal compound 20 (liquid crystal material) having a cholesteric structure.

(Cholesteric Liquid Crystalline Phase)

It is known that the cholesteric liquid crystalline phase exhibits selective reflectivity at a specific wavelength.

A central wavelength of selective reflection (selective reflection center wavelength) λ of a general cholesteric liquid crystalline phase depends on a helical pitch P in the cholesteric liquid crystalline phase and satisfies a relationship of λ=n×P with an average refractive index n of the cholesteric liquid crystalline phase. Therefore, the selective reflection center wavelength can be adjusted by adjusting the helical pitch.

The selective reflection center wavelength of the cholesteric liquid crystalline phase increases as the pitch P increases.

As described above, the helical pitch P refers to one pitch (helical period) of the helical structure of the cholesteric liquid crystalline phase, in other words, one helical turn. That is, the helical pitch refers to the length in a helical axis direction in which a director (in the case of a rod-shaped liquid crystal, a major axis direction) of the liquid crystal compound constituting the cholesteric liquid crystalline phase rotates by 360°.

The helical pitch of the cholesteric liquid crystalline phase depends on the kind of the chiral agent used together with the liquid crystal compound and the concentration of the chiral agent added during the formation of the cholesteric liquid crystal layer. Therefore, a desired helical pitch can be obtained by adjusting these conditions.

The details of the adjustment of the pitch can be found in “Fuji Film Research & Development” No. 50 (2005), p. 60 to 63. As a method of measuring a sense of helix and a helical pitch, a method described in “Introduction to Experimental Liquid Crystal Chemistry”, (the Japanese Liquid Crystal Society, 2007, Sigma Publishing Co., Ltd.), p. 46, and “Liquid Crystal Handbook” (the Editing Committee of Liquid Crystal Handbook, Maruzen Publishing Co., Ltd.), p. 196 can be used.

The cholesteric liquid crystalline phase exhibits selective reflectivity with respect to left or right circularly polarized light at a specific wavelength. Whether or not the reflected light is right circularly polarized light or left circularly polarized light is determined depending on a helical twisted direction (sense) of the cholesteric liquid crystalline phase. Regarding the selective reflection of the circularly polarized light by the cholesteric liquid crystalline phase, in a case where the helical twisted direction of the cholesteric liquid crystal layer is right, right circularly polarized light is reflected, and in a case where the helical twisted direction of the cholesteric liquid crystal layer is left, left circularly polarized light is reflected.

A turning direction of the cholesteric liquid crystalline phase can be adjusted by adjusting the kind of the liquid crystal compound that forms the cholesteric liquid crystal layer and/or the kind of the chiral agent to be added.

In addition, a half-width Δλ (nm) of a selective reflection wavelength range (circularly polarized light reflection wavelength range) where selective reflection is exhibited depends on Δn of the cholesteric liquid crystalline phase and the helical pitch P and satisfies a relationship of Δλ=Δn×P. Therefore, the width of the selective reflection wavelength range can be controlled by adjusting Δn. Δn can be adjusted by adjusting a kind of a liquid crystal compound for forming the cholesteric liquid crystal layer and a mixing ratio thereof, and a temperature during alignment immobilization.

The half-width of the reflection wavelength range is adjusted depending on the use of the diffraction element and may be, for example, 10 to 500 nm and is preferably 20 to 300 nm and more preferably 30 to 100 nm.

(Method of Forming Cholesteric Liquid Crystal Layer)

The cholesteric liquid crystal layer 16 can be formed by immobilizing a cholesteric liquid crystalline phase in a layer shape using the liquid crystal composition according to the embodiment of the present invention.

The structure in which a cholesteric liquid crystalline phase is immobilized may be a structure in which the alignment of the liquid crystal compound as a cholesteric liquid crystalline phase is immobilized. Typically, the structure in which a cholesteric liquid crystalline phase is immobilized is preferably a structure which is obtained by making the polymerizable liquid crystal compound to be in a state where a cholesteric liquid crystalline phase is aligned, polymerizing and curing the polymerizable liquid crystal compound with ultraviolet irradiation, heating, or the like to form a layer having no fluidity, and concurrently changing the state of the polymerizable liquid crystal compound into a state where the alignment state is not changed by an external field or an external force.

The structure in which a cholesteric liquid crystalline phase is immobilized is not particularly limited as long as the optical characteristics of the cholesteric liquid crystalline phase are maintained, and the liquid crystal compound 20 in the cholesteric liquid crystal layer does not necessarily exhibit liquid crystallinity. For example, the molecular weight of the polymerizable liquid crystal compound may be increased by a curing reaction such that the liquid crystallinity thereof is lost.

In a case where the cholesteric liquid crystal layer is formed, it is preferable that the cholesteric liquid crystal layer is formed by applying the liquid crystal composition according to the embodiment of the present invention to a surface where the cholesteric liquid crystal layer is to be formed, aligning the liquid crystal compound to a state of a cholesteric liquid crystalline phase, and curing the liquid crystal compound.

That is, in a case where the cholesteric liquid crystal layer is formed on the photo-alignment film 14, it is preferable that the cholesteric liquid crystal layer obtained by immobilizing a cholesteric liquid crystalline phase is formed by applying the liquid crystal composition to the photo-alignment film 14, aligning the liquid crystal compound to a state of a cholesteric liquid crystalline phase, and curing the liquid crystal compound.

For the application of the liquid crystal composition, a printing method such as ink jet or scroll printing or a well-known method such as spin coating, bar coating, or spray coating capable of uniformly applying liquid to a sheet-shaped material can be used.

The applied liquid crystal composition is optionally dried and/or heated and then is cured to form the cholesteric liquid crystal layer. In the drying and/or heating step, the liquid crystal compound in the liquid crystal composition only has to be aligned to a cholesteric liquid crystalline phase. In the case of heating, the heating temperature is preferably 200° C. or lower and more preferably 130° C. or lower.

The aligned liquid crystal compound is optionally further polymerized. Regarding the polymerization, thermal polymerization or photopolymerization using light irradiation may be performed, and photopolymerization is preferable. Regarding the light irradiation, ultraviolet light is preferably used. The irradiation energy is preferably 20 mJ/cm² to 50 J/cm² and more preferably 50 to 1500 mJ/cm². In order to promote a photopolymerization reaction, light irradiation may be performed under heating conditions or in a nitrogen atmosphere. The wavelength of irradiated ultraviolet light is preferably 250 to 430 nm.

The thickness of the cholesteric liquid crystal layer is not particularly limited, and the thickness with which a required light reflectivity can be obtained may be appropriately set depending on the use of the optical element 10, the light reflectivity required for the cholesteric liquid crystal layer, the material for forming the cholesteric liquid crystal layer, and the like.

(Liquid Crystal Alignment Pattern of Cholesteric Liquid Crystal Layer)

In the optical element 10 according to the embodiment of the present invention, the cholesteric liquid crystal layer 16 as the optically-anisotropic layer has the liquid crystal alignment pattern in which the direction of the optical axis 20A derived from the liquid crystal compound 20 forming the cholesteric liquid crystalline phase changes while continuously rotating in the one in-plane direction of the cholesteric liquid crystal layer.

The optical axis 20A derived from the liquid crystal compound 20 is an axis having the highest refractive index in the liquid crystal compound 20. For example, in a case where the liquid crystal compound 20 is a rod-like liquid crystal compound, the optical axis 20A is along a rod-like major axis direction. In the following description, the optical axis 20A derived from the liquid crystal compound 20 will also be referred to as “the optical axis 20A of the liquid crystal compound 20” or “the optical axis 20A”.

FIG. 3 conceptually shows a plan view of the cholesteric liquid crystal layer 16.

The plan view is a view showing the cholesteric liquid crystal layer 16 in a case where the optical element 10 is seen from the top in FIG. 1, that is, a view in a case where the optical element 10 is seen from a thickness direction (laminating direction of the respective layers (films)).

In addition, in FIG. 3, in order to clarify the configuration of the optical element 10 according to the embodiment of the present invention, only the liquid crystal compound 20 on the surface of the photo-alignment film 14 is shown as in FIG. 1.

As shown in FIG. 3, on the surface of the photo-alignment film 14, the liquid crystal compound 20 forming the cholesteric liquid crystal layer 16 has the liquid crystal alignment pattern in which the direction of the optical axis 20A changes while continuously rotating in the predetermined one in-plane direction indicated by arrow X in a plane of the cholesteric liquid crystal layer 16 according to the alignment pattern formed on the photo-alignment film 14 as the lower layer. In the example shown in the drawing, the liquid crystal compound 20 has the liquid crystal alignment pattern in which the optical axis 20A of the liquid crystal compound 20 changes while continuously rotating clockwise in the arrow X direction.

The liquid crystal compound 20 forming the cholesteric liquid crystal layer 16 is two-dimensionally arranged in a direction orthogonal to the arrow X and the one in-plane direction (arrow X direction).

In the following description, the direction orthogonal to the arrow X direction will be referred to as “Y direction” for convenience of description. That is, the arrow Y direction is a direction orthogonal to the one in-plane direction in which the direction of the optical axis 20A of the liquid crystal compound 20 changes while continuously rotating in a plane of the cholesteric liquid crystal layer. Accordingly, in FIGS. 1, 2, and FIG. 4 described below, the Y direction is a direction orthogonal to the paper plane.

Specifically, “the direction of the optical axis 20A of the liquid crystal compound 20 changes while continuously rotating in the arrow X direction (the predetermined one in-plane direction)” represents that an angle between the optical axis 20A of the liquid crystal compound 20, which is arranged in the arrow X direction, and the arrow X direction varies depending on positions in the arrow X direction, and the angle between the optical axis 20A and the arrow X direction sequentially changes from θ to θ+180° or θ−180° in the arrow X direction.

A difference between the angles of the optical axes 20A of the liquid crystal compound 20 adjacent to each other in the arrow X direction is preferably 45° or less, more preferably 15° or less, and still more preferably less than 15°.

On the other hand, in the liquid crystal compound 20 forming the cholesteric liquid crystal layer 16, the directions of the optical axes 20A are the same in the Y direction orthogonal to the arrow X direction, that is, the Y direction orthogonal to the one in-plane direction in which the optical axis 20A continuously rotates.

In other words, in the liquid crystal compound 20 forming the cholesteric liquid crystal layer 16, angles between the optical axes 20A of the liquid crystal compound 20 and the arrow X direction are the same in the Y direction.

In the cholesteric liquid crystal layer 16, in the liquid crystal alignment pattern of the liquid crystal compound 20, the length (distance) over which the optical axis 20A of the liquid crystal compound 20 rotates by 180θ in the arrow X direction in which the optical axis 20A changes while continuously rotating in a plane is the length Λ of the single period in the liquid crystal alignment pattern.

That is, a distance between centers of two liquid crystal compounds 20 in the arrow X direction is the length Λ of the single period, the two liquid crystal compounds having the same angle in the arrow X direction. Specifically, as shown in FIG. 3 (FIG. 4), a distance between centers in the arrow X direction of two liquid crystal compounds 20 in which the arrow X direction and the direction of the optical axis 20A match each other is the length Λ of the single period. In the following description, the length Λ of the single period will also be referred to as “single period Λ”.

In the cholesteric liquid crystal layer 16, in the liquid crystal alignment pattern of the cholesteric liquid crystal layer, the single period Λ is repeated in the arrow X direction, that is, in the one in-plane direction in which the direction of the optical axis 20A changes while continuously rotating.

The cholesteric liquid crystal layer obtained by immobilizing a cholesteric liquid crystalline phase typically reflects incident light (circularly polarized light) by specular reflection.

On the other hand, the cholesteric liquid crystal layer 16 reflects incident light in a state where it is tilted in the arrow X direction with respect to the specular reflection. The cholesteric liquid crystal layer 16 has the liquid crystal alignment pattern in which the optical axis 20A changes while continuously rotating in the arrow X direction in a plane (the predetermined one in-plane direction). Hereinafter, the description will be made with reference to FIG. 4.

For example, the cholesteric liquid crystal layer 16 selectively reflects left circularly polarized light R_{L} of red light. Accordingly, in a case where light is incident into the cholesteric liquid crystal layer 16, the cholesteric liquid crystal layer 16 reflects only left circularly polarized light R_{L} of red light and allows transmission of the other light.

In a case where the left circularly polarized light R_{L} of red light incident into the cholesteric liquid crystal layer 16 is reflected from the cholesteric liquid crystal layer, the absolute phase changes depending on the directions of the optical axes 20A of the respective liquid crystal compounds 20.

Here, in the cholesteric liquid crystal layer 16, the optical axis 20A of the liquid crystal compound 20 changes while rotating in the arrow X direction (the one in-plane direction). Therefore, the amount of change in the absolute phase of the incident left circularly polarized light R_{L} of red light varies depending on the directions of the optical axes 20A.

Further, the liquid crystal alignment pattern formed in the cholesteric liquid crystal layer 16 is a pattern that is periodic in the arrow X direction. Therefore, as conceptually shown in FIG. 4, an absolute phase Q that is periodic in the arrow X direction corresponding to the direction of the optical axis 20A is assigned to the left circularly polarized light R_{L} of red light incident into the cholesteric liquid crystal layer 16.

In addition, the direction of the optical axis 20A of the liquid crystal compound 20 with respect to the arrow X direction is uniform in the arrangement of the liquid crystal compound 20 in the Y direction orthogonal to arrow X direction.

As a result, in the cholesteric liquid crystal layer 16, an equiphase surface E that is tilted in the arrow X direction with respect to an XY plane is formed for the left circularly polarized light R_{L} of red light.

Therefore, the left circularly polarized light R_{L} of red light is reflected in the normal direction of the equiphase surface E, and the reflected left circularly polarized light R_{L} of red light is reflected in a direction that is tilted in the arrow X direction with respect to the XY plane (main surface of the cholesteric liquid crystal layer).

Accordingly, by appropriately setting the arrow X direction as the one in-plane direction in which the optical axis 20A rotates, a direction in which the left circularly polarized light R_{L} of red light is reflected can be adjusted.

For example, by reversing the arrow X direction such that the rotation direction of the optical axis 20A is clockwise to the left side in the drawing, the reflection direction of the left circularly polarized light R_{L} of red light is opposite to that of FIG. 4.

In addition, by reversing the rotation direction of the optical axis 20A of the liquid crystal compound 20 toward the arrow X direction, a reflection direction of the left circularly polarized light R_{L} of red light can be reversed.

That is, in FIGS. 1 to 4, the rotation direction of the optical axis 20A toward the arrow X direction is clockwise, and the left circularly polarized light R_{L} of red light is tilted and reflected toward the arrow X direction. By setting the rotation direction of the optical axis 20A to be counterclockwise, the left circularly polarized light R_{L} of red light is tilted and reflected toward a direction opposite to the arrow X direction.

Further, in the cholesteric liquid crystal layer having the same liquid crystal alignment pattern, the reflection direction is reversed by adjusting the helical turning direction of the liquid crystal compound 20, that is, the turning direction of circularly polarized light to be reflected.

The cholesteric liquid crystal layer 16 shown in FIG. 4 has a right-twisted helical turning direction, selectively reflects right circularly polarized light, and has the liquid crystal alignment pattern in which the optical axis 20A rotates clockwise in the arrow X direction. As a result, the right circularly polarized light is reflected in a state where it is tilted in the arrow X direction.

Accordingly, in the cholesteric liquid crystal layer that has a left-twisted helical turning direction, selectively reflects left circularly polarized light, and has the liquid crystal alignment pattern in which the optical axis 20A rotates clockwise in the arrow X direction, the left circularly polarized light is reflected in a state where it is tilted in a direction opposite to the arrow X direction.

As described above, the cholesteric liquid crystal layer 16 of the optical element 10 has the liquid crystal alignment pattern in which the optical axis 20A of the liquid crystal compound 20 continuously rotates in the one in-plane direction. In addition, in the liquid crystal alignment pattern, the length over which the optical axis 20A rotates by 1800 is set as the single period Λ (refer to FIGS. 1, 3, and 4).

In the cholesteric liquid crystal layer 16 having the liquid crystal alignment pattern, as the single period Λ decreases, the angle of reflected light with respect to the above-described incidence light increases. That is, as the single period Λ decreases, reflected light can be reflected in a state where it is largely tilted with respect to incidence light.

The single period Λ is not particularly limited and may be appropriately set depending on, for example, the use of the optical element.

The single period Λ of the cholesteric liquid crystal layer 16 is preferably 2.00 μm or less, more preferably 1.60 μm or less, still more preferably 0.80 μm or less, and still more preferably a wavelength λ or shorter of incident light. The lower limit is not particularly limited and is 0.20 m or more in many cases.

By setting the single period Λ to be in 2.00 μm or less, the diffraction angle of reflected light by the cholesteric liquid crystal layer 16 can be made to be sufficiently large. Therefore, for example, in a case where the optical element according to the embodiment of the present invention is used as a diffraction element for causing light to be incident into the light guide plate of the above-described AR glasses, the light can be incident into the light guide plate at a sufficient angle for propagation by total reflection.

Regarding the single period Λ of the liquid crystal alignment pattern, the same can be applied to a patterned liquid crystal layer 32 in an optical element 30 according to another aspect of the present invention.

A plurality of the optical elements according to the embodiment of the present invention may be laminated to be used.

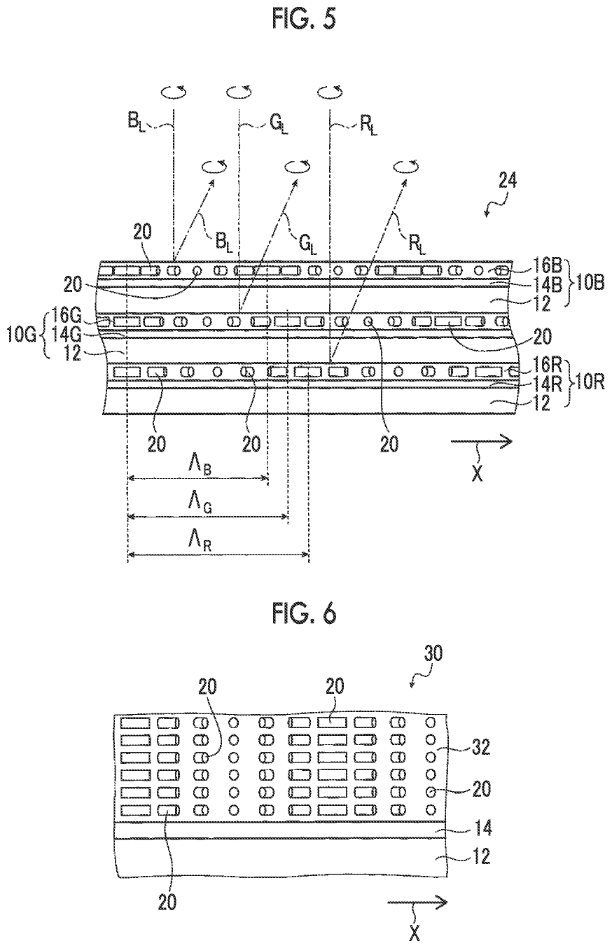

FIG. 5 shows an example of this laminate.

A laminated optical element 24 conceptually shown in FIG. 5 includes three diffraction elements according to the embodiment of the present invention including an R optical element 10R, a G optical element 10G, and a B optical element 10B.

The R optical element 10R corresponds to red light and includes the support 12, a photo-alignment film 14R, and a cholesteric liquid crystal layer 16R that reflects left circularly polarized light R_{L} of red light.

The G optical element 10G corresponds to green light and includes the support 12, a photo-alignment film 14G, and a cholesteric liquid crystal layer 16G that reflects left circularly polarized light G_{L} of green light.

The B optical element 10B corresponds to blue light and includes the support 12, a photo-alignment film 14B, and a cholesteric liquid crystal layer 16B that reflects left circularly polarized light B_{L} of blue light.

In the R optical element 10R, the G optical element 10G, and the B optical element 10B, all of the supports, the alignment film, and the cholesteric liquid crystal layers are the same as the support 12, the photo-alignment film 14, and the cholesteric liquid crystal layer 16 in the above-described optical element 10. In this case, each of the cholesteric liquid crystal layers (diffraction elements) has the helical pitch P corresponding to the wavelength range where light is selectively reflected.

Here, in the R optical element 10R, the G optical element 10G, and the B optical element 10B, a permutation of the lengths of the selective reflection center wavelengths of the cholesteric liquid crystal layers and a permutation of the lengths of the single periods Λ in the liquid crystal alignment patterns of the cholesteric liquid crystal layers are the same as each other.

That is, in the laminated optical element 24, the selective reflection center wavelength of the R optical element 10R corresponding to reflection of red light is the longest, the selective reflection center wavelength of the G optical element 10G corresponding to reflection of green light is the second longest, and the selective reflection center wavelength of the B optical element 10B corresponding to reflection of blue light is the shortest.

Accordingly, in the R optical element 10R, the G optical element 10G, and the B optical element 10B, the single period Λ_{R} of the cholesteric liquid crystal layer of the R optical element 10R is the longest, the single period Λ_{G} of the cholesteric liquid crystal layer of the G optical element 10G is the second longest, and the single period Λ_{B} of the cholesteric liquid crystal layer of the B optical element 10B is the shortest.

A reflection angle of light from the cholesteric liquid crystal layer in which the optical axis 20A of the liquid crystal compound 20 continuously rotates in the one in-plane direction (arrow X direction) varies depending on wavelengths of light to be reflected. Specifically, as the wavelength of light increases, the angle of reflected light with respect to incidence light increases. Accordingly, red light reflected from the R optical element 10R has the largest angle of reflected light with respect to incidence light, green light reflected from the G optical element 10G has the second largest angle of reflected light with respect to incidence light, and blue light reflected from the B optical element 10B has the smallest angle of reflected light with respect to incidence light.

On the other hand, as described above, in the cholesteric liquid crystal layer having the liquid crystal alignment pattern in which the optical axis 20A of the liquid crystal compound 20 rotates in the one in-plane direction, as the single period Λ over which the optical axis 20A in the liquid crystal alignment pattern rotates by 1800 decreases, the angle of reflected light with respect to incidence light increases.

In the R optical element 10R, the G optical element 10G, and the B optical element 10B, the permutation of the lengths of the selective reflection center wavelengths of the diffraction elements (cholesteric liquid crystal layers) and the permutation of the lengths (Λ_{R}, Λ_{G}, and Λ_{B}) of the single periods Λ in the liquid crystal alignment patterns of the cholesteric liquid crystal layers are the same as each other. Thus, as shown in FIG. 5 using the left circularly polarized light R_{L} of red light, the left circularly polarized light G_{L} of green light, and the left circularly polarized light B_{L} of blue light as an example, the wavelength dependence on the reflection angle of light reflected from the laminated optical element 24 is significantly reduced, and light components having different wavelengths can be reflected substantially in the same direction.

In a case where the optical elements according to the embodiment of the present invention having different wavelength ranges where light is selectively reflected are laminated, the laminating order is not limited.

In the present invention, in a case where a plurality of the optical elements are laminated, the configuration including the R optical element 10R, the G optical element 10G, and the B optical element 10B as shown in FIG. 5 is not particularly limited.

For example, the laminated optical element 24 may include two layers appropriately selected from the R optical element 10R, the G optical element 10G, and the B optical element 10B. Further, instead of one or more selected from the R optical element 10R, the G optical element 10G, and the B optical element 10B, or in addition to the R optical element 10R, the G optical element 10G, and the B optical element 10B, the laminated optical element 24 may include an optical element that selectively reflects ultraviolet light and/or an optical element that selectively reflects infrared light.

In a case where a plurality of the optical elements according to the embodiment of the present invention are laminated, the present invention is not limited to the configuration where the optical elements having different selective reflection center wavelengths are laminated as shown in FIG. 5.

For example, the laminated optical element 24 may include two cholesteric liquid crystal layers having the same selective reflection center wavelength and different turning directions of circularly polarized light to be reflected, that is, different helical turning directions (senses) in a cholesteric liquid crystalline phase.

With this configuration, both of right circularly polarized light and left circularly polarized light in incidence light can be reflected, and the amount of light reflected with respect to the incidence light can be increased.

In the optical element 10 in the above-described example, the cholesteric liquid crystal layer is used as the optically-anisotropic layer. However, the present invention is not limited to this configuration. That is, in the optical element according to the embodiment of the present invention, as the optically-anisotropic layer, various optically-anisotropic layers can be used as long as they are formed of a composition including a liquid crystal compound and they have the liquid crystal alignment pattern in which the optical axis 20A derived from the liquid crystal compound 20 continuously rotates in at least one in-plane direction.

For example, in the optical element according to the embodiment of the present invention, an optically-anisotropic layer that has the liquid crystal alignment pattern where the optical axis continuously rotates in at least one in-plane direction and in which the liquid crystal compound is not helically twisted in the thickness direction and does not rotate can also be used.

FIG. 6 conceptually shows an example of the optically-anisotropic layer.

The optical element 30 shown in FIG. 6 includes the support 12, the photo-alignment film 14, and the patterned liquid crystal layer 32.

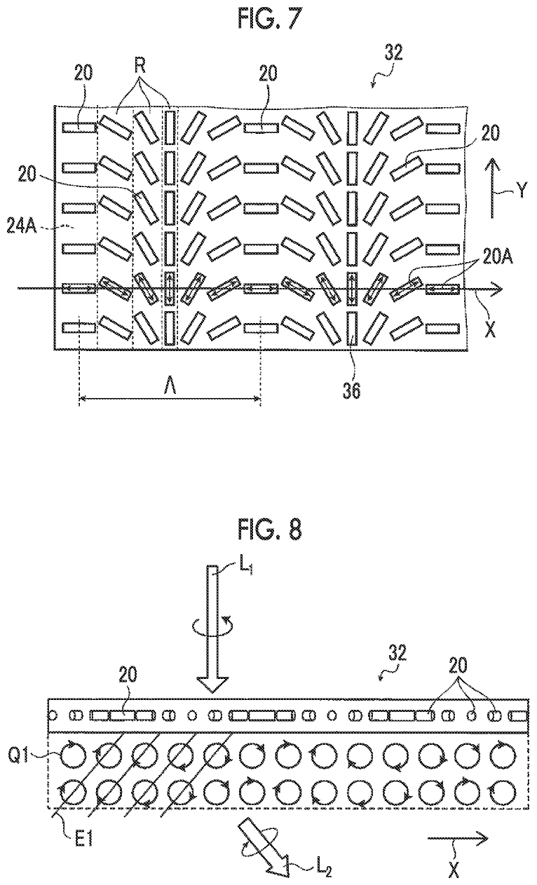

In the optical element 30, the patterned liquid crystal layer 32 is the optically-anisotropic layer according to the embodiment of the present invention, and has the same liquid crystal alignment pattern as the above-described cholesteric liquid crystal layer 16. Accordingly, as conceptually shown in FIG. 7, as in the cholesteric liquid crystal layer 16, the patterned liquid crystal layer 32 also has the liquid crystal alignment pattern in which the optical axis 20A of the liquid crystal compound 20 continuously rotates clockwise in the arrow X direction. FIG. 7 also shows only the liquid crystal compound of the surface of the photo-alignment film 14 as in FIG. 3.

In the patterned liquid crystal layer 32, the liquid crystal compound 20 forming diffraction element (liquid crystal layer) is not helically twisted in the thickness direction and does not rotate, the optical axes 20A are directed to the same direction in the thickness direction.

That is, the directions of the optical axes 20A derived from the liquid crystal compound 20 match each other in the thickness direction. The liquid crystal layer can be formed by not adding a chiral agent to a liquid crystal composition during the formation of the cholesteric liquid crystal layer.

In the optical element 30, the support 12 and the photo-alignment film 14 are the same as those in the above-described optical element 10 shown in FIG. 1.

As described above, the patterned liquid crystal layer 32 has the liquid crystal alignment pattern in which the direction of the optical axis 20A derived from the liquid crystal compound 20 changes while continuously rotating in the arrow X direction in a plane, that is, in the one in-plane direction indicated by arrow X.

On the other hand, regarding the liquid crystal compound 20 forming the patterned liquid crystal layer 32, the liquid crystal compounds 20 having the same direction of the optical axes 20A are arranged at regular intervals in the Y direction orthogonal to the arrow X direction, that is, the Y direction orthogonal to the one in-plane direction in which the optical axis 20A continuously rotates. In other words, regarding the liquid crystal compound 20 forming the patterned liquid crystal layer 32, in the liquid crystal compounds 20 arranged in the Y direction, angles between the directions of the optical axes 20A and the arrow X direction are the same.

In the liquid crystal compounds arranged in the Y direction in the patterned liquid crystal layer 32, the angles between the optical axes 20A and the arrow X direction (the one in-plane direction in which the direction of the optical axis of the liquid crystal compound 20 rotates) are the same. Regions where the liquid crystal compounds 20 in which the angles between the optical axes 20A and the arrow X direction are the same are disposed in the Y direction will be referred to as “regions R”.

In this case, it is preferable that an in-plane retardation (Re) value of each of the regions R is a half wavelength, that is, λ/2. The in-plane retardation is calculated from the product of a difference Δn in refractive index generated by refractive index anisotropy of the region R and the thickness of the optically-anisotropic layer. Here, the difference in refractive index generated by refractive index anisotropy of the region R in the optically-anisotropic layer is defined by a difference between a refractive index of a direction of an in-plane slow axis of the region R and a refractive index of a direction orthogonal to the direction of the slow axis. That is, the difference Δn in refractive index generated by refractive index anisotropy of the region R is the same as a difference between a refractive index of the liquid crystal compound 20 in the direction of the optical axis 20A and a refractive index of the liquid crystal compound 20 in a direction perpendicular to the optical axis 20A in a plane of the region R. That is, the difference Δn in refractive index is the same as the difference in refractive index of the liquid crystal compound 20.

In a case where circularly polarized light is incident into the above-described patterned liquid crystal layer 32, the light is refracted such that the direction of the circularly polarized light is converted.

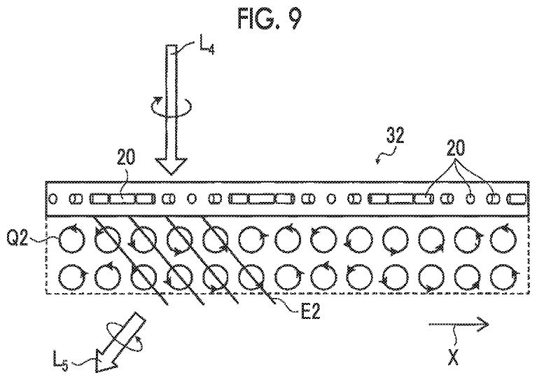

This action is conceptually shown in FIGS. 8 and 9. In the patterned liquid crystal layer 32, the value of the product of the difference in refractive index of the liquid crystal compound and the thickness of the optically-anisotropic layer is λ/2.

As shown in FIG. 8, in a case where the value of the product of the difference in refractive index of the liquid crystal compound in the patterned liquid crystal layer 32 and the thickness of the optically-anisotropic layer is λ/2 and incidence light L₁ as left circularly polarized light is incident into the patterned liquid crystal layer 32, the incidence light L₁ transmits through the patterned liquid crystal layer 32 to be imparted with a retardation of 180°, and the transmitted light L₂ is converted into right circularly polarized light.

In addition, in a case where the incidence light L₁ transmits through the patterned liquid crystal layer 32, an absolute phase thereof changes depending on the direction of the optical axis 20A of each of the liquid crystal compounds 20. In this case, the direction of the optical axis 20A changes while rotating in the arrow X direction. Therefore, the amount of change in the absolute phase of the incidence light L₁ varies depending on the direction of the optical axis 20A. Further, the liquid crystal alignment pattern that is formed in the patterned liquid crystal layer 32 is a pattern that is periodic in the arrow X direction. Therefore, as shown in FIG. 8, the incidence light L₁ transmitted through the patterned liquid crystal layer 32 is imparted with an absolute phase Q1 that is periodic in the arrow X direction corresponding to the direction of each of the optical axes 20A. As a result, an equiphase surface E1 that is tilted in a direction opposite to the arrow X direction is formed.

Therefore, the transmitted light L₂ is refracted to be tilted in a direction perpendicular to the equiphase surface E1 and travels in a direction different from a traveling direction of the incidence light L₁. This way, the incidence light L₁ of the left circularly polarized light is converted into the transmitted light L₂ of right circularly polarized light that is tilted by a predetermined angle in the arrow X direction with respect to an incidence direction.

On the other hand, as shown in FIG. 9, in a case where the value of the product of the difference in refractive index of the liquid crystal compound in the patterned liquid crystal layer 32 and the thickness of the optically-anisotropic layer is λ/2 and incidence light L₄ of right circularly polarized light is incident into the patterned liquid crystal layer 32, the incidence light L₄ transmits through the patterned liquid crystal layer 32 to be imparted with a retardation of 180°, and the transmitted light L₄ is converted into transmitted light L₅ of left circularly polarized light.

In addition, in a case where the incidence light L₄ transmits through the patterned liquid crystal layer 32, an absolute phase thereof changes depending on the direction of the optical axis 20A of each of the liquid crystal compounds 20. In this case, the direction of the optical axis 20A changes while rotating in the arrow X direction. Therefore, the amount of change in the absolute phase of the incidence light L₄ varies depending on the direction of the optical axis 20A. Further, the liquid crystal alignment pattern that is formed in the patterned liquid crystal layer 32 is a pattern that is periodic in the arrow X direction. Therefore, as shown in FIG. 9, the incidence light L₄ transmitted through the patterned liquid crystal layer 32 is imparted with an absolute phase Q2 that is periodic in the arrow X direction corresponding to the direction of each of the optical axes 20A.

Here, the incidence light L₄ is right circularly polarized light. Therefore, the absolute phase Q2 that is periodic in the arrow X direction corresponding to the direction of the optical axis 20A is opposite to the incidence light L₁ as left circularly polarized light. As a result, in the incidence light L₄, an equiphase surface E2 that is tilted in the arrow X direction opposite to that of the incidence light L₁ is formed.

Therefore, the incidence light L₄ is refracted to be tilted in a direction perpendicular to the equiphase surface E2 and travels in a direction different from a traveling direction of the incidence light L₄. This way, the incidence light L₄ is converted into the transmitted light L₅ of left circularly polarized light that is tilted by a predetermined angle in a direction opposite to the arrow X direction with respect to an incidence direction.

As in the cholesteric liquid crystal layer 16 or the like, by changing the single period Λ of the liquid crystal alignment pattern formed in the patterned liquid crystal layer 32, refraction angles of the transmitted light components L₂ and L₅ can be adjusted. Specifically, even in the patterned liquid crystal layer 32, as the single period Λ of the liquid crystal alignment pattern decreases, light components transmitted through the liquid crystal compounds 20 adjacent to each other more strongly interfere with each other. Therefore, the transmitted light components L₂ and L₅ can be more largely refracted. As described above, the single period Λ is preferably 1.6 μm or less, more preferably 0.8 μm or less, and still more preferably a wavelength λ or shorter of incident light.

In addition, as in the cholesteric liquid crystal layer 16 or the like, even in the patterned liquid crystal layer 32, as the wavelengths of the incidence light components L₁ and L₄ increase, the transmitted light components L₂ and L₅ are more largely refracted.

Further, by reversing the rotation direction of the optical axis 20A of the liquid crystal compound 20 that rotates in the arrow X direction, the refraction direction of transmitted light can be reversed. That is, in the example FIGS. 6 to 9, the rotation direction of the optical axis 20A toward the arrow X direction is clockwise. By setting this rotation direction to be counterclockwise, the refraction direction of transmitted light can be reversed.

In the above-described example, in the optically-anisotropic layer of the optical element, the direction of the optical axis 20A derived from the liquid crystal compound 20 continuously changes only in the arrow X direction.

However, the optically-anisotropic layer of the optical element according to the embodiment of the present invention is not limited to this configuration, and various configurations can be used as long as they are formed of a composition including a liquid crystal compound and the optical axis 20A of the liquid crystal compound 20 continuously rotates in the one in-plane direction.

For example, an optically-anisotropic layer 34 conceptually shown in a plan view of FIG. 11 can be used, in which a liquid crystal alignment pattern is a concentric circular pattern having a concentric circular shape where the one in-plane direction in which the direction of the optical axis of the liquid crystal compound 20 changes while continuously rotating moves from an inner side toward an outer side.

Alternatively, a liquid crystal alignment pattern can also be used where the one in-plane direction in which the direction of the optical axis of the liquid crystal compound 20 changes while continuously rotating is provided in a radial shape from the center of the optically-anisotropic layer 34 instead of a concentric circular shape.

FIG. 11 shows only the liquid crystal compound 20 of the surface of the alignment film as in FIGS. 3 and 7. However, as shown in FIGS. 2 and 6, the optically-anisotropic layer 34 has the helical structure in which the liquid crystal compound 20 on the surface of the alignment film is helically twisted and laminated as described above.

In the optically-anisotropic layer 34 shown in FIG. 11, the optical axis (not shown) of the liquid crystal compound 20 is a longitudinal direction of the liquid crystal compound 20.

In the optically-anisotropic layer 34, the direction of the optical axis of the liquid crystal compound 20 changes while continuously rotating in a direction in which a large number of optical axes move to the outer side from the center of the optically-anisotropic layer 34, for example, a direction indicated by an arrow X1, a direction indicated by an arrow X2, a direction indicated by an arrow X3, or . . . .

In addition, as a preferable aspect, for example, the direction of the optical axis of the liquid crystal compound changes while rotating in a radial shape from the center of the optically-anisotropic layer 34 as shown in FIG. 11. In the aspect shown in FIG. 11, counterclockwise alignment is shown. The rotation directions of the optical axes indicated by the respective arrows X1, X2, and X3 in FIG. 11 are counterclockwise toward the outer side from the center.

In circularly polarized light incident into the optically-anisotropic layer 34 having the above-described liquid crystal alignment pattern, the absolute phase changes depending on individual local regions having different directions of optical axes of the liquid crystal compound 20. In this case, the amount of change in absolute phase varies depending on the directions of the optical axes of the liquid crystal compound 20 into which circularly polarized light is incident.

This way, in the optically-anisotropic layer 34 having the concentric circular liquid crystal alignment pattern, that is, the liquid crystal alignment pattern in which the optical axis changes while continuously rotating in a radial shape, reflection or transmission of incidence light can be allowed as diverging light or converging light depending on the rotation direction of the optical axis of the liquid crystal compound 20 and the direction of circularly polarized light to be reflected.

That is, in a case where the optically-anisotropic layer 34 is a cholesteric liquid crystal layer, by setting the liquid crystal alignment pattern in a concentric circular shape, the optical element according to the embodiment of the present invention exhibits, for example, a function as a concave mirror or a convex mirror. In addition, in a case where the optically-anisotropic layer 34 is a patterned liquid crystal layer, by setting the liquid crystal alignment pattern in a concentric circular shape, the optical element according to the embodiment of the present invention exhibits, for example, a function as a convex lens or a concave lens.

Here, in a case where the liquid crystal alignment pattern of the optically-anisotropic layer is concentric circular such that the optical element functions as a concave mirror or a convex lens, it is preferable that the length of the single period Λ over which the optical axis rotates by 180° in the liquid crystal alignment pattern gradually decreases from the center of the optically-anisotropic layer 34 toward the outer direction in the one in-plane direction in which the optical axis continuously rotates.

As described above, the reflection angle of light with respect to an incidence direction increases as the length of the single period Λ in the liquid crystal alignment pattern decreases. Accordingly, the length of the single period Λ in the liquid crystal alignment pattern gradually decreases from the center of the optically-anisotropic layer 34 toward the outer direction in the one in-plane direction in which the optical axis continuously rotates. As a result, light can be further collected, and the performance as a concave mirror or a convex lens can be improved.

In the present invention, in a case where the optical element functions as a convex mirror or a concave lens, it is preferable that the continuous rotation of the optical axis in the liquid crystal alignment pattern is reversed from the center of the optically-anisotropic layer 34. In a case where the optically-anisotropic layer is a cholesteric liquid crystal layer, the turning direction of circularly polarized light to be reflected, that is, the sense of helix may be reversed.

In addition, by gradually decreasing the length of the single period Λ over which the optical axis rotates by 180° from the center of the optically-anisotropic layer 34 toward the outer direction in the one in-plane direction in which the optical axis continuously rotates, the optically-anisotropic layer 34 can further diffuse light, and the performance as a convex mirror and a concave lens can be improved.

In the present invention, in a case where the optical element is made to function as a convex mirror and a concave lens or as a concave mirror and a convex lens, it is preferable that the optical element satisfies Expression (1).

φ(r)=(π/λ)[(r²+f²)^{1/2}−f] Expression (1)

Here, r represents a distance from the center of a concentric circle and is represented by Expression “r=(x²+y²)^{1/2}”. x and y represent in-plane positions, and (x,y)=(0,0) represents the center of the concentric circle. Φ(r) represents an angle of the optical axis at the distance r from the center, X represents the selective reflection center wavelength of the cholesteric liquid crystal layer, and f represents a desired focal length.

In the present invention, depending on the uses of the optical element, conversely, the length of the single period Λ in the concentric circular liquid crystal alignment pattern may gradually increase from the center of the optically-anisotropic layer 34 toward the outer direction in the one in-plane direction in which the optical axis continuously rotates.

Further, depending on the uses of the optical element such as a case where it is desired to provide a light amount distribution in reflected light, a configuration in which regions having partially different lengths of the single periods Λ in the one in-plane direction in which the optical axis continuously rotates are provided can also be used instead of the configuration in which the length of the single period Λ gradually changes in the one in-plane direction in which the optical axis continuously rotates.

Further, the optical element according to the embodiment of the present invention may include: a cholesteric liquid crystal layer in which the single period Λ is uniform over the entire surface; and a cholesteric liquid crystal layer in which regions having different lengths of the single periods Λ are provided. This point is also applicable to a configuration in which the optical axis continuously rotates only in the one in-plane direction as shown in FIG. 1 below.

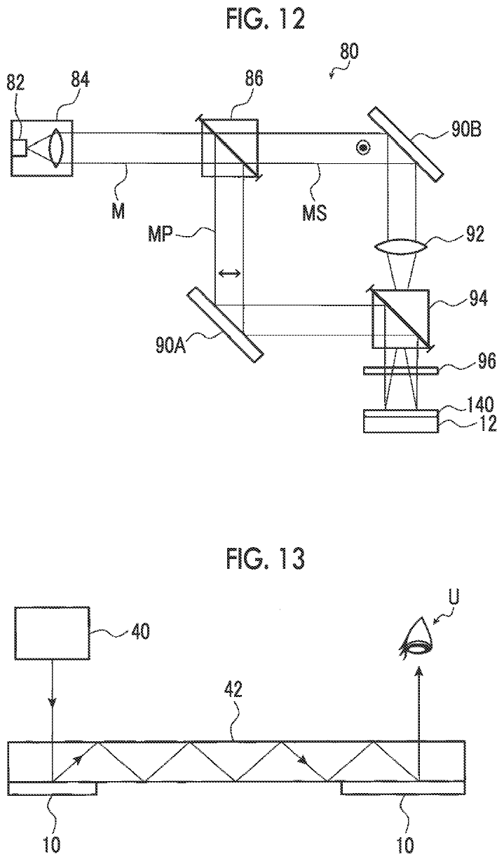

FIG. 12 conceptually shows an example of an exposure device that forms the concentric circular alignment pattern in the photo-alignment film 14 corresponding to the optically-anisotropic layer 34.

An exposure device 80 includes: a light source 84 that includes a laser 82; a polarization beam splitter 86 that divides the laser light M emitted from the laser 82 into S polarized light MS and P polarized light MP; a mirror 90A that is disposed on an optical path of the P polarized light MP; a mirror 90B that is disposed on an optical path of the S polarized light MS; a lens 92 that is disposed on the optical path of the S polarized light MS; a polarization beam splitter 94; and a λ/4 plate 96.

The P polarized light MP that is split by the polarization beam splitter 86 is reflected from the mirror 90A to be incident into the polarization beam splitter 94. On the other hand, the S polarized light MS that is split by the polarization beam splitter 86 is reflected from the mirror 90B and is collected by the lens 92 to be incident into the polarization beam splitter 94.

The P polarized light MP and the S polarized light MS are multiplexed by the polarization beam splitter 94, are converted into right circularly polarized light and left circularly polarized light by the λ/4 plate 96 depending on the polarization direction, and are incident into the photoalignment precursor film 140 on the support 12.

Here, due to interference between the right circularly polarized light and the left circularly polarized light, the polarization state of light with which the photoalignment precursor film 140 is irradiated periodically changes according to interference fringes. The intersecting angle between the right circularly polarized light and the left circularly polarized light changes from the inside to the outside of the concentric circle. Therefore, an exposure pattern in which the pitch changes from the inner side to the outer side can be obtained. As a result, in the photo-alignment film 14, a concentric circular alignment pattern in which the alignment state periodically changes can be obtained.

In the exposure device 80, the length Λ of the single period in the liquid crystal alignment pattern in which the optical axis of the liquid crystal compound 20 continuously rotates by 180° can be controlled by changing the refractive power of the lens 92 (the F number of the lens 92), the focal length of the lens 92, the distance between the lens 92 and the photo-alignment film 14, and the like.

In addition, by adjusting the refractive power of the lens 92 (the F number of the lens 92), the length Λ of the single period in the liquid crystal alignment pattern in the one in-plane direction in which the optical axis continuously rotates can be changed. Specifically, In addition, the length Λ of the single period in the liquid crystal alignment pattern in the one in-plane direction in which the optical axis continuously rotates can be changed depending on a light spread angle at which light is spread by the lens 92 due to interference with parallel light.

More specifically, in a case where the refractive power of the lens 92 is weak, light is approximated to parallel light. Therefore, the length Λ of the single period in the liquid crystal alignment pattern gradually decreases from the inner side toward the outer side, and the F number increases. Conversely, in a case where the refractive power of the lens 92 becomes stronger, the length Λ of the single period in the liquid crystal alignment pattern rapidly decreases from the inner side toward the outer side, and the F number decreases.

This way, the configuration of changing the length of the single period Λ over which the optical axis rotates by 180° in the one in-plane direction in which the optical axis continuously rotates can also be used in the configuration shown in FIGS. 1 to 9 in which the optical axis 20A of the liquid crystal compound 20 continuously rotates only in the one in-plane direction as the arrow X direction.

For example, by gradually decreasing the single period Λ of the liquid crystal alignment pattern in the arrow X direction, an optical element that allows reflection or transmission of light to be collected can be obtained.

Further, depending on the uses of the optical element such as a case where it is desired to provide a light amount distribution in reflected light and transmitted light, a configuration in which regions having partially different lengths of the single periods Λ in the arrow X direction are provided can also be used instead of the configuration in which the length of the single period Λ gradually changes in the arrow X direction. For example, as a method of partially changing the single period Λ, for example, a method of scanning and exposing the photo-alignment film to be patterned while freely changing a polarization direction of laser light to be collected can be used.

Hereinabove, the optical element according to the embodiment of the present invention has been described above. However, the present invention is not limited to the above-described examples, and various improvements and modifications can be made within a range not departing from the scope of the present invention.

[Light Guide Element]

A light guide element according to the embodiment of the present invention includes the optical element according to the embodiment of the present invention and a light guide plate.

In the example shown in FIG. 13, the light guide element includes a light guide plate 42 and the optical element (laminated optical element) 10 and has a configuration where the optical element 10 is bonded to one end part of a main surface of the light guide plate 42 and the optical element 10 is bonded to another end part of the main surface of the light guide plate 42.

In the light guide element, the optical element 10 is used as an incidence diffraction element that reflects incident light at an angle of total reflection in the light guide plate 42 to be incident into the light guide plate 42, and is used as an emission diffraction element that reflects the light that is guided by total reflection in the light guide plate 42 at angle not satisfying total reflection conditions to be emitted from the light guide plate 42.

### EXAMPLES

Hereinafter, the characteristics of the present invention will be described in detail using Examples and Comparative Examples. Materials, chemicals, used amounts, material amounts, ratios, treatment details, treatment procedures, and the like shown in the following examples can be appropriately changed within a range not departing from the scope of the present invention. Accordingly, the scope of the present invention is not limited to the following specific examples.

### Comparative Example 1 Examples 1 to 9

[Preparation of Optical Element]

<Support and Saponification Treatment of Support>

As the support, a commercially available triacetyl cellulose film “Z-TAC” (manufactured by Fujifilm Corporation) was used.

The support was caused to pass through a dielectric heating roll at a temperature of 60° C. such that the support surface temperature was increased to 40° C.

Next, an alkali solution shown below was applied to a single surface of the support using a bar coater in an application amount of 14 mL (liter)/m², the support was heated to 110° C., and the support was transported for 10 seconds under a steam far infrared heater (manufactured by Noritake Co., Ltd.).

Next, 3 mL/m² of pure water was applied to a surface of the support to which the alkali solution was applied using the same bar coater. Next, water cleaning using a foundry coater and water draining using an air knife were repeated three times, and then the support was transported and dried in a drying zone at 70° C. for 10 seconds. As a result, the alkali saponification treatment was performed on the surface of the support.

Alkali Solution

| | | |
|---|---|---|
| Potassium hydroxide | 4.70 | parts by mass |
| Water | 15.80 | parts by mass |
| Isopropyl alcohol | 63.70 | parts by mass |
| Surfactant SF-1 | 1.0 | part by mass |
| C₁₄H₂₉O(CH₂CH₂O)₂OH | | |
| Propylene glycol | 14.8 | parts by mass |

<Formation of Undercoat Layer>

The following coating liquid for forming an undercoat layer was continuously applied to the surface of the support on which the alkali saponification treatment was performed using a #8 wire bar. The support on which the coating film was formed was dried using hot air at 60° C. for 60 seconds and was dried using hot air at 100° C. for 120 seconds. As a result, an undercoat layer was formed.

Coating Liquid for Forming Undercoat Layer

| | | |
|---|---|---|
| The following modified polyvinyl alcohol | 2.40 | parts by mass |
| Isopropyl alcohol | 1.60 | parts by mass |
| Methanol | 36.00 | parts by mass |
| Water | 60.00 | parts by mass |

Modified Polyvinyl Alcohol

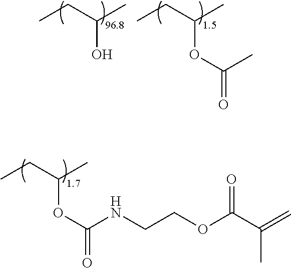

<Formation of Alignment Film>

The following coating liquid for forming an alignment film was continuously applied to the support on which the undercoat layer was formed using a #2 wire bar. The support on which the coating film of the coating liquid for forming an alignment film was formed was dried using a hot plate at 60° C. for 60 seconds. As a result, an alignment film was formed.

Coating Liquid for Forming Alignment Film

| | | |
|---|---|---|
| The following material D for photo-alignment | 1.00 | part by mass |
| Water | 16.00 | parts by mass |
| Butoxyethanol | 42.00 | parts by mass |
| Propylene glycol monomethyl ether | 42.00 | parts by mass |

Material D for Photo-Alignment

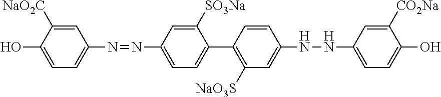

<Exposure of Alignment Film>

The exposed film was exposed using the exposure device shown in FIG. 10 to form an alignment film P-1 having an alignment pattern.

In the exposure device, a laser that emits laser light having a wavelength (325 nm) was used as the laser. The exposure amount of the interference light was 2000 mJ/cm². The single period (the length over which the optical axis derived from the liquid crystal compound rotates by 180°) of an alignment pattern formed by interference of two laser beams was controlled by changing an intersecting angle (intersecting angle β) between the two beams.

<Formation of Optically-Anisotropic Layer>

As the composition forming the optically-anisotropic layer, the following composition E (specifically, E-1 to E-10 in Table 1 below) was prepared.

Composition E

| Rod-like liquid crystal compound shown in | parts by mass | |
|---|---|---|
| Table 1 below shown in Table 1 below | | |
| Disk-like liquid crystal compound shown in | parts by mass | |
| Table 1 below shown in Table 1 below | | |
| Polymerization initiator (IRGACURE (registered | 3.00 | parts by mass |
| trade name) 907, manufactured by BASF SE) | | |
| The following leveling agent T-1 | 0.08 | parts by mass |
| Methyl ethyl ketone | 927.7 | parts by mass |

Leveling Agent T-1

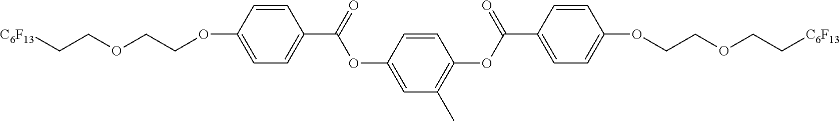

The optically-anisotropic layer was formed by applying multiple layers of the composition E to the alignment film P-1.

The application of the multiple layers refers to repetition of the following processes including: preparing a first liquid crystal immobilized layer by applying the composition E for forming the first layer to the alignment film, heating the composition E, cooling the composition E, and irradiating the composition E with ultraviolet light for curing; and preparing a second or subsequent liquid crystal immobilized layer by applying the composition E for forming the second or subsequent layer to the formed liquid crystal immobilized layer, heating the composition E, cooling the composition E, and irradiating the composition E with ultraviolet light for curing as described above.

Even in a case where the liquid crystal layer was formed by the application of the multiple layers such that the film thickness of the liquid crystal layer was large, the alignment direction of the alignment film was reflected from a lower surface of the liquid crystal layer to an upper surface thereof.

Regarding the first liquid crystal layer, the composition E was applied to the alignment film P-1 to form a coating film, the coating film was heated using a hot plate at 120° C., the coating film was cooled to 60° C., and the coating film was irradiated with ultraviolet light having a wavelength of 365 nm at an irradiation dose of 2000 mJ/cm² using a high pressure mercury lamp in a nitrogen atmosphere. As a result, the alignment of the liquid crystal compound was immobilized. In this case, the film thickness of the first liquid crystal layer was 0.3 m.

Regarding the second or subsequent liquid crystal layer, the composition was applied to the first liquid crystal layer, and the applied composition was heated, cooled, and irradiated with ultraviolet light for curing under the same conditions as described above. As a result, a liquid crystal immobilized layer (cured layer) was prepared.

This way, by repeating the application multiple times such that the in-plane retardation (Re) reached a 325 nm, an optically-anisotropic layer was obtained, and an optical element G (specifically, G-1 to G-10 in Table 1 below) was prepared. The retardation value is a value that is ½ a wavelength of 650 nm of a light source for evaluation used in measurement of the diffraction efficiency described below.

It was verified using a polarization microscope that the optically-anisotropic layer according to the example had a periodically aligned surface as shown in FIG. 8. In the liquid crystal alignment pattern of the optically-anisotropic layer, the single period Λ over which the optical axis derived from the liquid crystal compound rotated by 180° was 1.0 m. The period Λ was obtained by measuring the period of the brightness pattern observed with a polarization microscope under crossed nicols conditions.

[Evaluation]

<Measurement of Difference Δn₅₅₀ in Refractive Index>

Regarding each of the compositions E-1 to E-10 used in Examples 1 to 9 and Comparative Example 1, the difference Δn₅₅₀ in refractive index was measured using the above-described method.

The following evaluation value was determined based on the obtained Δn₅₅₀. The results are shown in Table 1 below.
A: 0.20≤Δn₅₅₀.
B: Δn₅₅₀<0.20.

<Measurement of Elastic Constant>

Regarding each of the compositions E-1 to E-10 used in Examples 1 to 9 and Comparative Example 1, the ratio (K22/K11) of the elastic constants of the composition other than methyl ethyl ketone was measured using the above-described method.

The following evaluation value was determined based on the obtained K22/K11. The results are shown in Table 1 below.
A: 0.75≤K22/K11.
B: 0.70≤K22/K11<0.75
C: K22/K11<0.7

<Measurement of Diffraction Efficiency>

An evaluation optical system where a light source for evaluation, a polarizer, a ¼ wave plate, the optical element according to the embodiment of the present invention, and a screen were disposed in this order was prepared. As the light source for evaluation, a laser pointer having a wavelength of 650 nm was used. As the ¼ wave plate, SAQWP05M-700 manufactured by Thorlabs, Inc. was used. The slow axis of the ¼ wave plate was disposed at 45° relative to the absorption axis of the polarizer. In addition, the optical element according to the embodiment of the present invention was disposed such that the glass surface faced the light source side.

In a case where light emitted from the light source for evaluation and transmitted through the polarizer and the ¼ wave plate was incident into the optical element according to the embodiment of the present invention to be perpendicular to the film surface, and a part of the light transmitted through the optical element was diffracted, and a plurality of bright points were able to be observed on the screen.

The intensities of each of the diffracted light components corresponding to the bright points on the screen and the zero-order light were measured using a power meter, and the diffraction efficiency was calculated using the following expression.

Diffraction Efficiency=(Intensity of First-Order Light)/(Intensity of Zero-Order Light+Intensity of Diffracted Light other than First-Order Light)

The following evaluation value was determined based on the obtained diffraction efficiency. The results are shown in Table 1 below.
A: the diffraction efficiency is 99% or more.
B: the diffraction efficiency is 95% or more and less than 99%.
C: the diffraction efficiency is 90% or more and less than 95%.
D: the diffraction efficiency was less than 90%.

TABLE 1

| | Liquid Crystal Composition | | | | | | | | |
|---|---|---|---|---|---|---|---|---|---|
| | | Rod-Like Liquid | | Disk-Like Liquid | | | | | |
| | | Crystal | | Crystal | | | | | |
| | | Composition | | Composition | | | Difference | | |
| | | | Content | | Index | | Δn550 in | Optical Element | |
| | | | (Part(s) | | (Part(s) | | Refractive | | Diffraction |
| | Kind | Kind | by Mass) | Kind | by Mass) | K22/K11 | Index | Kind | Efficiency |
| Comparative | E-1 | A-1 | 100 | None | 0 | C | B | G-1 | D |
| Example 1 | | | | | | | | | |
| Example 1 | E-2 | A-1 | 80 | B-1 | 20 | A | B | G-2 | B |
| Example 2 | E-3 | A-1 | 80 | B-2 | 20 | A | B | G-3 | B |
| Example 3 | E-4 | A-1 | 80 | B-3 | 20 | A | B | G-4 | B |
| Example 4 | E-5 | A-1 | 80 | B-4 | 20 | A | B | G-5 | B |
| Example 5 | E-6 | A-1 | 80 | B-5 | 20 | A | B | G-6 | B |
| Example 6 | E-7 | A-2 | 96 | B-5 | 4 | C | A | G-7 | C |
| Example 7 | E-8 | A-2 | 85 | B-5 | 15 | B | A | G-8 | B |
| Example 8 | E-9 | A-2 | 80 | B-5 | 20 | A | A | G-9 | A |
| Example 9 | E-10 | A-2 | 70 | B-5 | 30 | A | B | G-10 | B |

Structural formulas of the rod-like liquid crystal compounds and the disk-like liquid crystal compounds shown in Table 1 are shown below.

Rod-Like Liquid Crystal Compound A-1 (a mixture of liquid crystal compounds represented by the following formulas (numerical values are represented by mass %).

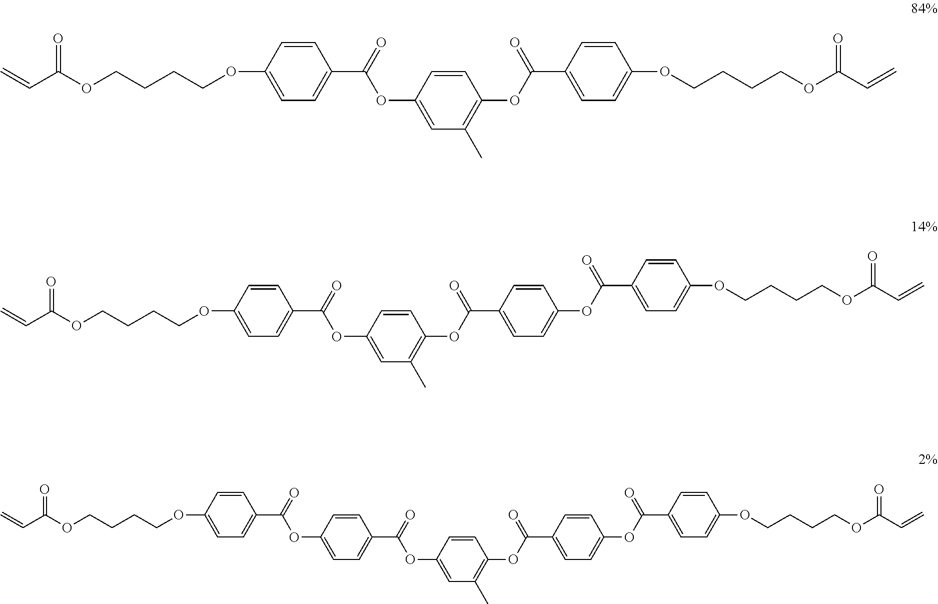

Rod-Like Liquid Crystal Compound A-2

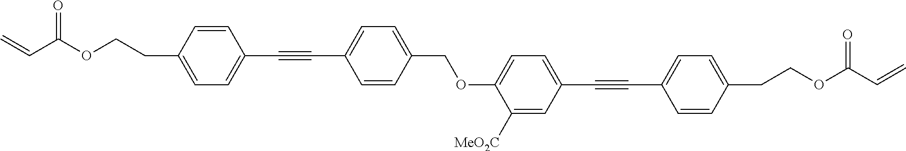 [SMILES: C=CC(=O)OCCc1ccc(C#Cc2ccc(COc3ccc(C#Cc4ccc(CCOC(=O)C=C)cc4)cc3C(=O)OC)cc2)cc1]

Disk-Like Liquid Crystal Compound B-1

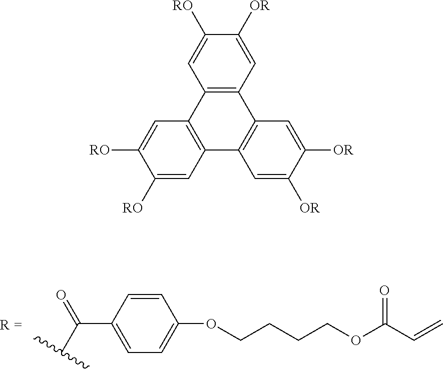

Disk-Like Liquid Crystal Compound B-2

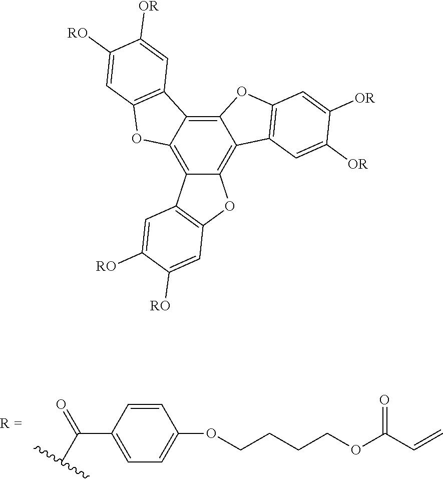

Disk-Like Liquid Crystal Compound B-3

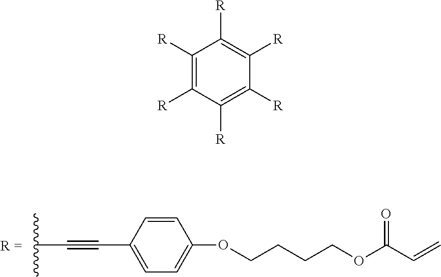

Disk-Like Liquid Crystal Compound B-4

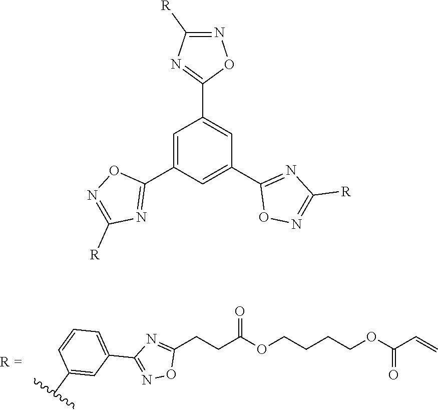

Disk-Like Liquid Crystal Compound B-5

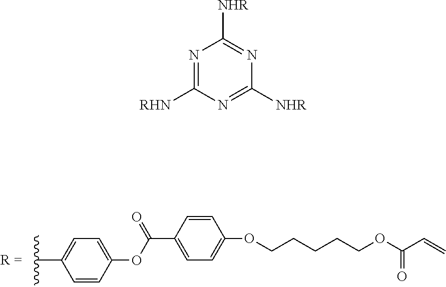

It was found from the results shown in Table 1 that, in a case where the liquid crystal composition where the disk-like liquid crystal compound is not mixed and the ratio between the twist elastic constant K22 and the splay elastic constant K11 does not satisfy 0.7≤K22/K11 is used, the diffraction efficiency of the obtained optical element was poor (Comparative Example 1).

On the other hand, it was found from the results shown in Table 1 that, in a case where the liquid crystal composition where the rod-like liquid crystal compound but also the disk-like liquid crystal compound are mixed is used, an optical element having an excellent diffraction efficiency can be prepared (Examples 1 to 9).

In particular, it was found from a comparison between Examples 7 and 8 that, in a case where the liquid crystal composition where the ratio between the twist elastic constant K22 and the splay elastic constant K11 satisfies 0.75≤K22/K11 (evaluated A) is used, the diffraction efficiency of the prepared optical element is further improved.

In addition, it can be verified from a comparison between Examples 8 and 9 that, in a case where the liquid crystal composition where the difference Δn₅₅₀ in refractive index generated by refractive index anisotropy is 0.2 or higher (evaluated as A) is used, the diffraction efficiency of the prepared optical element is further improved.

The optical element according to the embodiment of the present invention can bend light having any wavelength at any angle depending on the design of the in-plane alignment pattern. Due to this property, the optical element according to the embodiment of the present invention can be used for various optical devices and can contribute to a reduction in size and an increase in the efficiency in the optical devices. Examples of the optical device including the optical element that bent visible light include a glass type display device such as AR/virtual reality (VR) and a stereoscopic image display device that displays a real image in the air. In addition, examples of the optical device including the optical element that bends infrared light include an optical communication device and sensor.

### EXPLANATION OF REFERENCES

10, 30: optical element
12: support
14, 14R, 14G, 14B: photo-alignment film
16: cholesteric liquid crystal layer
20: rod-like liquid crystal compound
20A: optical axis
32: patterned liquid crystal layer
34: optically-anisotropic layer
40: display
42: light guide plate
60, 80: exposure device
62, 82: laser
64, 84: light source
68, 86, 94: polarization beam splitter
70A, 70B, 90A, 90B: mirror
72A, 72B, 96: λ/4 plate
92: lens
140: photoalignment precursor film
B_{R}: blue right circularly polarized light
G_{R}: right circularly polarized light of green light
R_{R}: right circularly polarized light of red light
M: laser light
MA, MB: beam
MP: P polarized light
MS: S polarized light
P_{O}: linearly polarized light
P_{R}: right circularly polarized light
P_{L}: left circularly polarized light
Q, Q1, Q2: absolute phase
E, E1, E2: equiphase surface
L₁, L₄: incidence light
L₂, L₅: transmitted light

What is claimed is:

1. A liquid crystal composition comprising:
a liquid crystal compound,
wherein the liquid crystal composition includes a rod-like liquid crystal compound and a disk-like liquid crystal compound, and
a ratio between a twist elastic constant K22 and a splay elastic constant K11 of the liquid crystal composition satisfies 0.7≤K22/K11.

2. The liquid crystal composition according to claim 1,
wherein a difference Δn₅₅₀ in refractive index generated by refractive index anisotropy of the liquid crystal composition is 0.2 or more.

3. The liquid crystal composition according to claim 1,
wherein a content of the disk-like liquid crystal compound in the liquid crystal composition with respect to a total mass of the rod-like liquid crystal compound and the disk-like liquid crystal compound in the liquid crystal composition is 5 to 25 mass %.

4. The liquid crystal composition according to claim 1,
wherein the rod-like liquid crystal compound is a compound represented by Formula (I), 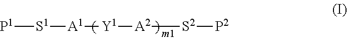
in Formula (I),
P¹ and P² each independently represent a hydrogen atom or a substituent,
S¹ and S² each independently represent a single bond or a divalent linking group,
A¹ and A² each independently represent a non-aromatic ring, an aromatic ring, or an aromatic heterocycle which may have a substituent,
in a case where a plurality of A²'s are present, the plurality of A²'s may be the same as or different from each other,
Y¹ represents —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, —OCH₂CH₂O—, —SCH₂CH₂S—, or a single bond,
in a case where a plurality of Y¹'s are present, the plurality of Y¹'s may be the same as or different from each other, and
m1 represents an integer of 1 to 12.

5. The liquid crystal composition according to claim 1,
wherein the disk-like liquid crystal compound is a compound represented by Formula (II), 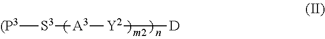
in Formula (II),
P³ represents a hydrogen atom or a substituent,
a plurality of P³'s may be the same as or different from each other,
S³ represents a single bond or a divalent linking group,
a plurality of S³'s may be the same as or different from each other,
A³ represent a non-aromatic ring, an aromatic ring, or an aromatic heterocycle which may have a substituent,
a plurality of A³'s may be the same as or different from each other,
Y² represents —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, —OCH₂CH₂O—, —SCH₂CH₂S—, or a single bond,
a plurality of Y²'s may be the same as or different from each other,
m2 represents an integer of 0 to 5,
n represents an integer of 3 to 20, and
D represents an n-valent disk-like core.

6. The liquid crystal composition according to claim 4,
wherein at least one Y¹ in Formula (I) represents —C≡C—.

7. An optical element comprising:
an optically-anisotropic layer that is formed of a liquid crystal composition including a liquid crystal compound,
wherein the liquid crystal composition includes a rod-like liquid crystal compound and a disk-like liquid crystal compound, and
the optically-anisotropic layer has a liquid crystal alignment pattern in which a direction of an optical axis derived from the liquid crystal compound changes while continuously rotating in at least one in-plane direction.

8. An optical element comprising:
an optically-anisotropic layer that is formed of the liquid crystal composition according to claim 1,
wherein the liquid crystal composition includes a rod-like liquid crystal compound and a disk-like liquid crystal compound, and
the optically-anisotropic layer has a liquid crystal alignment pattern in which a direction of an optical axis derived from the liquid crystal compound changes while continuously rotating in at least one in-plane direction.

9. The optical element according to claim 7,
wherein the directions of the optical axes in the optically-anisotropic layer match each other in a thickness direction.

10. The optical element according to claim 7,
wherein the optically-anisotropic layer has a region where the direction of the optical axis is twisted in a thickness direction and rotates.

11. The optical element according to claim 7,
wherein in a case where a length over which the direction of the optical axis rotates by 180° in a plane is set as a single period, the optically-anisotropic layer has regions having different lengths of the single periods in the liquid crystal alignment pattern.

12. The optical element according to claim 7,
wherein a single period in the liquid crystal alignment pattern gradually decreases in the one in-plane direction in which the direction of the optical axis changes while continuously rotating in the liquid crystal alignment pattern.

13. The optical element according to claim 7,
wherein the liquid crystal alignment pattern of the optically-anisotropic layer is a concentric circular pattern having a concentric circular shape where the one in-plane direction in which the direction of the optical axis changes while continuously rotating moves from an inner side toward an outer side.

14. Alight guide element comprising:
the optical element according to claim 7; and
a light guide plate.

15. The liquid crystal composition according to claim 2,
wherein a content of the disk-like liquid crystal compound in the liquid crystal composition with respect to a total mass of the rod-like liquid crystal compound and the disk-like liquid crystal compound in the liquid crystal composition is 5 to 25 mass %.

16. The liquid crystal composition according to claim 2,
wherein the rod-like liquid crystal compound is a compound represented by Formula (I), 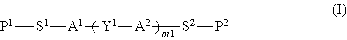
in Formula (I),
P¹ and P² each independently represent a hydrogen atom or a substituent,
S¹ and S² each independently represent a single bond or a divalent linking group,
A¹ and A² each independently represent a non-aromatic ring, an aromatic ring, or an aromatic heterocycle which may have a substituent,
in a case where a plurality of A²'s are present, the plurality of A²'s may be the same as or different from each other,
Y¹ represents —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, —OCH₂CH₂O—, —SCH₂CH₂S—, or a single bond,
in a case where a plurality of Y¹'s are present, the plurality of Y¹'s may be the same as or different from each other, and
m1 represents an integer of 1 to 12.

17. The liquid crystal composition according to claim 2,
wherein the disk-like liquid crystal compound is a compound represented by Formula (II), 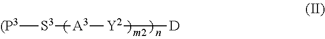
in Formula (II),
P³ represents a hydrogen atom or a substituent,
a plurality of P³'s may be the same as or different from each other,
S³ represents a single bond or a divalent linking group,
a plurality of S³'s may be the same as or different from each other,
A³ represent a non-aromatic ring, an aromatic ring, or an aromatic heterocycle which may have a substituent,
a plurality of A³'s may be the same as or different from each other,
Y² represents —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, —OCH₂CH₂O—, —SCH₂CH₂S—, or a single bond,
a plurality of Y²'s may be the same as or different from each other,
m2 represents an integer of 0 to 5,
n represents an integer of 3 to 20, and
D represents an n-valent disk-like core.

18. The liquid crystal composition according to claim 16,
wherein at least one Y¹ in Formula (I) represents —C≡C—.

19. An optical element comprising:
an optically-anisotropic layer that is formed of the liquid crystal composition including the liquid crystal compound according to claim 2,
wherein the liquid crystal composition includes a rod-like liquid crystal compound and a disk-like liquid crystal compound, and
the optically-anisotropic layer has a liquid crystal alignment pattern in which a direction of an optical axis derived from the liquid crystal compound changes while continuously rotating in at least one in-plane direction.

20. The optical element according to claim 8,
wherein the directions of the optical axes in the optically-anisotropic layer match each other in a thickness direction.
